(19) United States
(12) Patent Application Publication
(10) Pub. No.: US 2018/0024354 A1
(43) Pub. Date: Jan. 25, 2018

(54) VEHICLE DISPLAY CONTROL DEVICE AND VEHICLE DISPLAY UNIT

(71) Applicant: DENSO CORPORATION, Kariya-city, Aichi-pref. (JP)

(72) Inventors: Shingo SHIBATA, Kariya-city, Aichi-pref. (JP); Ayako KOTANI, Kariya-city, Aichi-pref. (JP)

(21) Appl. No.: 15/549,489

(22) PCT Filed: Jan. 26, 2016
(86) PCT No.: PCT/JP2016/000371

§ 371 Date: Aug. 8, 2017

(30) Foreign Application Priority Data
Feb. 9, 2015 (JP) 2015-023621
Dec. 3, 2015 (JP) 2015-236915

(51) Int. Cl. G02B 27/01; B60R 21/00; B60K 35/00; G08G 1/16; B60W 30/165

(52) U.S. Cl. CPC G02B 27/01; G08G 1/16; B60W 30/165; B60K 35/00; B60R 21/00; B60R 2021/01095

(57) ABSTRACT

A vehicle display control device that controls to display a virtual image in a subject vehicle equipped with a head-up display that displays the virtual image in association with one front obstacle in outside scenery by projecting a display image on a projection member includes: an image storage device that stores, as the display image, a highlighting image for highlighting the front obstacle by a linear portion surrounding the front obstacle with a margin spaced apart from the front obstacle at a virtual image display position corresponding to an entire range less than an entire circumference other than a lower side of a periphery of the front obstacle; and a virtual image display control device that is provided by at least one processor and controls the virtual image display position and the virtual image display size.

### CROSS REFERENCE TO RELATED APPLICATIONS

This application is based on Japanese Patent Applications No. 2015-23621 filed on Feb. 9, 2015, and No. 2015-236915 filed on Dec. 3, 2015, the disclosures of which are incorporated herein by reference.

### TECHNICAL FIELD

The present disclosure relates to a vehicle display control device and a vehicle display unit including the same.

### BACKGROUND ART

Conventionally, there has been widely known a head-up display (HUD) that projects a display image onto a projection member for transmitting outside scenery therethrough in a subject vehicle, thereby virtually displaying the display image in association with a front obstacle in the outside scenery. In order to control the virtual image display by the HUD, Patent Literatures 1 and 2 each disclose a vehicle display control technique for virtually displaying as a display image a highlighting image that highlights a front obstacle.

Specifically, in the technique disclosed in Patent Literature 1, a virtual image display position and a virtual image display size are controlled so that a highlighting image having an annular linear shape is superimposed on a front obstacle transmitted through a projection member. According to the technique, even when the virtual image display position of the highlighting image deviates within the range of a control error caused by, for example, disturbance, it is possible to maintain the association of the highlighting image with the front obstacle by a superimposed state.

However, in the technique disclosed in Patent Literature 1, part of the front obstacle is hidden behind the highlighting image, and a user may thus feel inconvenience. In view of this, in the technique disclosed in Patent Literature 2, a virtual image display position and a virtual image display size are controlled so that a highlighting image having a rectangular linear shape surrounds the entire periphery of a front obstacle transmitted through a projection member with a margin left between the highlighting image and the front obstacle. According to the technique, even when the virtual image display position of the highlighting image deviates within the range of a control error, it is possible to prevent part of the front obstacle from being hidden behind the highlighting image by the margin to reduce inconvenience to a user.

In the technique disclosed in Patent Literature 2, when the highlighting image deviates upward, leftward, or rightward with respect to the front obstacle, although a user feels the deviation, it looks as if the front obstacle is pointed by the highlighting image on the same plane because of the following reason. Typically, a space is present on the upper side, the left side, and the right side of the front obstacle. Thus, a user is less likely to feel separation in the front-rear direction with respect to the front obstacle in a linear portion of the rectangular linear highlighting image, the linear portion extending right and left or up and down and being superimposed on the space.

However, in the technique disclosed in Patent Literature 2, when the highlighting image deviates downward with respect to the front obstacle, a user is likely to feel the deviation, and it looks as if the front obstacle is not pointed by the highlighting image because of the following reason. The ground is present under the front obstacle. Thus, in a linear portion of the rectangular linear highlighting image, the linear portion extending right and left and being superimposed on the ground, the deviation with respect to the front obstacle is likely to be conspicuous because the horizontal line is recalled by the association with the ground. When the front obstacle is a preceding vehicle, the horizontal line is particularly likely to be recalled in a linear portion extending right and left along a bumper of the preceding vehicle, and the conspicuousness of deviation becomes remarkable. Thus, in the linear portion extending right and left under the front obstacle, a user is likely to feel downward deviation as separation in the front-rear direction with respect to the obstacle. As a result, the association with the front obstacle becomes ambiguous, which may reduce the highlighting effect or give a user illusion as if the front obstacle becomes separated.

### PRIOR ART LITERATURES

### Patent Literature

Patent Literature 1: WO-2009/072366-A

Patent Literature 2: JP-2005-343351-A

### SUMMARY OF INVENTION

It is an object of the present disclosure to provide a vehicle display control device that appropriately highlights a front obstacle by virtual image display of a highlighting image and a vehicle display unit including the same.

According to a first aspect of the present disclosure, a vehicle display control device that controls to display a virtual image in a subject vehicle equipped with a head-up display that displays the virtual image in association with at least one front obstacle in outside scenery by projecting a display image on a projection member for transmitting the outside scenery therethrough, includes: an image storage device that stores, as the display image, a highlighting image for highlighting the front obstacle by a linear portion having a virtual image display size surrounding the front obstacle with a margin spaced apart from the front obstacle at a virtual image display position corresponding to an entire range less than an entire circumference other than a lower side of a periphery of the front obstacle; and a virtual image display control device that is provided by at least one processor and controls the virtual image display position and the virtual image display size.

According to such a vehicle display control device, the highlighting image as the display image that highlights the front obstacle in the outside scenery is controlled to the virtual image display size surrounding the front obstacle with the margin left by the linear portion at the virtual image display position corresponding to the entire range less than a circle except the lower side of the periphery of the front obstacle. Thus, even if a user feels a deviation with respect to the front obstacle, it looks as if the front obstacle is pointed by the highlighting image that is superimposed on a space within the outside scenery on the upper side, left side, and right side of the front obstacle. Thus, the user is less likely to feel separation in the front-rear direction with respect to the front obstacle.

Accordingly, even if the virtual image display position of the highlighting image deviates within the range of a control error caused by, for example, disturbance, it is possible to maintain the association of the highlighting image with the front obstacle, and also possible to avoid the illusion as if the front obstacle becomes separated. Further, even if the virtual image display position of the highlighting image deviates within the control error range, the margin formed by the linear portion prevents part of the front obstacle from being hidden behind the highlighting image, which enables reduction in inconvenience to a user. As described above, the vehicle display control device that can achieve an inconvenience reducing action in addition to an association maintaining action and an illusion avoidance action makes it possible to appropriately highlight the front obstacle by the virtual image display of the highlighting image.

According to a second aspect of the present disclosure, a vehicle display control device that controls to display a virtual image in a subject vehicle equipped with a head-up display that displays the virtual image in association with at least one front obstacle in outside scenery by projecting a display image on a projection member for transmitting the outside scenery therethrough, includes: an image storage device that stores, as the display image, a highlighting image for highlighting the front obstacle by a first linear portion, having a first virtual image display size surrounding the front obstacle with a margin spaced apart from the front obstacle at a first virtual image display position corresponding to an entire range less than an entire circumference other than a lower side of a periphery of the front obstacle, and a second linear portion, having a second virtual image display size surrounding the front obstacle with a margin spaced apart from the front obstacle and a lower brightness than the first linear portion at a second virtual image display position between opposing ends of the first linear portion in the periphery of the front obstacle; and a virtual image display control device that is provided by at least one processor and controls a virtual image display position including the first virtual image display position and the second virtual image display position and a virtual image display size including the first virtual image display size and the second virtual image display size.

According to such a vehicle display control device, the highlighting image as the display image that highlights the front obstacle in the outside scenery is controlled to the virtual image display size surrounding the front obstacle with the margin left by the first linear portion at the virtual image display position corresponding to the entire range less than a circle except the lower side of the periphery of the front obstacle. Thus, even if a user feels a deviation with respect to the front obstacle, it looks as if the front obstacle is pointed by the first linear portion that is superimposed on a space within the outside scenery on the upper side, left side, and right side of the front obstacle. Thus, the user is less likely to feel separation in the front-rear direction with respect to the front obstacle.

Further, according the above vehicle display control device, the highlighting image size is controlled to the virtual image display size surrounding the front obstacle with the margin left by the second linear portion at the virtual image display position corresponding a part of the periphery of the front obstacle between the opposite ends of the first linear portion. Even when the second linear portion having a lower brightness than the first linear portion is superimposed on the ground which is present under the front obstacle, the fixation point of a user is likely to be more focused onto the first linear portion than the second linear portion. Thus, the second linear portion having a lower brightness weakens the association with the ground. Accordingly, the user is less likely to feel separation in the front-rear direction with respect to the front obstacle.

Accordingly, even if the virtual image display positions of the linear portions deviate within the range of a control error caused by, for example, disturbance, it is possible to maintain the association of the highlighting image with the front obstacle, and also possible to avoid the illusion as if the front obstacle becomes separated. Further, even if the virtual image display positions of the linear portions deviate within the control error range, the margins formed by the linear portions prevent part of the front obstacle from being hidden behind the highlighting image, which enables reduction in inconvenience to a user. As described above, the vehicle display control device that can achieve an inconvenience reducing action in addition to an association maintaining action and an illusion avoidance action makes it possible to appropriately highlight the front obstacle by the virtual image display of the highlighting image.

According to a third aspect of the present disclosure, a vehicle display unit includes: the vehicle display control device according to the first aspect or the second aspect; and the head-up display.

In such a vehicle display unit, the virtual image display position and the virtual image display size of the highlighting image by the HUD are controlled by the vehicle display control device of the first or second aspect. Thus, it is possible to appropriately highlight the front obstacle by the highlighting image.

### BRIEF DESCRIPTION OF DRAWINGS

The above and other objects, features and advantages of the present disclosure will become more apparent from the following detailed description made with reference to the accompanying drawings. In the drawings:

FIG. 1 is an internal view of a vehicle cabin of a subject vehicle equipped with a travel assist system according to a first embodiment;

FIG. 2 is a block diagram illustrating the travel assist system according to the first embodiment;

FIG. 3 is a structural diagram schematically illustrating a detailed configuration of an HUD of FIGS. 1 and 2;

FIG. 4 is a front view illustrating a virtual image display state by the HUD of FIGS. 1 to 3;

FIG. 5 is a flowchart illustrating a display control flow by the HCU of FIG. 2;

FIG. 6 is a front view for describing the action and effect of the first embodiment;

FIG. 7 is a flowchart illustrating a display control flow according to a second embodiment;

FIG. 8 is a front view illustrating a virtual image display state according to the second embodiment;

FIG. 9 is a flowchart illustrating a display control flow according to a third embodiment;

FIG. 10 is a front view illustrating a virtual image display state according to the third embodiment;

FIG. 11 is a front view illustrating a virtual image display state according to a fourth embodiment;

FIG. 12 is a flowchart illustrating a display control flow according to the fourth embodiment;

FIG. 13 is a front view for describing the action and effect of the fourth embodiment;

FIG. 14 is a flowchart illustrating a display control flow according to a fifth embodiment;

FIG. 15 is a front view illustrating a virtual image display state according to the fifth embodiment;

FIG. 16 is a flowchart illustrating a display control flow according to a sixth embodiment;

FIG. 17 is a front view illustrating a virtual image display state according to the sixth embodiment;

FIG. 18 is a flowchart illustrating a display control flow according to a seventh embodiment;

FIG. 19 is a front view illustrating a virtual image display state according to the seventh embodiment;

FIG. 20 is a flowchart illustrating a display control flow according to an eighth embodiment;

FIG. 21 is a front view illustrating a virtual image display state according to the eighth embodiment;

FIG. 22 is a flowchart illustrating a display control flow according to a ninth embodiment;

FIG. 23 is a front view illustrating a virtual image display state according to the ninth embodiment;

FIG. 24 is a flowchart illustrating a display control flow according to a tenth embodiment;

FIG. 25 is a front view illustrating a virtual image display state according to the tenth embodiment;

FIG. 26 is a flowchart illustrating a display control flow according to an eleventh embodiment;

FIG. 27 is a front view illustrating a virtual image display state according to the eleventh embodiment;

FIG. 28 is a flowchart illustrating a modification of FIG. 7;

FIG. 29 is a flowchart illustrating a modification of FIG. 9;

FIG. 30 is a flowchart illustrating a modification of FIG. 14;

FIG. 31 is a flowchart illustrating a modification of FIG. 16;

FIG. 32 is a flowchart illustrating a modification of FIG. 18;

FIG. 33 is a flowchart illustrating a modification of FIG. 20;

FIG. 34 is a flowchart illustrating a modification of FIG. 22;

FIG. 35 is a flowchart illustrating a modification of FIG. 24;

FIG. 36 is a flowchart illustrating a modification of FIG. 26;

FIG. 37 is a front view illustrating a modification of FIG. 4;

FIG. 38 is a front view illustrating a modification of FIG. 11;

FIG. 39 is a front view illustrating a modification of FIG. 11;

FIG. 40 is a front view illustrating a modification of FIG. 11; and

FIG. 41 is a block diagram illustrating a modification of FIG. 2.

### EMBODIMENTS FOR CARRYING OUT INVENTION

Hereinbelow, a plurality of embodiments of the present disclosure will be described with reference to the drawings. Corresponding elements in the respective embodiments may be denoted by the same reference signs to avoid repetitive description. In each of the embodiments, when only a part of a configuration is described, a configuration of the other preceding embodiments can be applied to the other part of the configuration. Further, in addition to a combination of configurations clearly stated in the respective embodiments, configurations of a plurality of embodiments may be partially combined even if not clearly stated unless there is an obstacle in the combination.

### First Embodiment

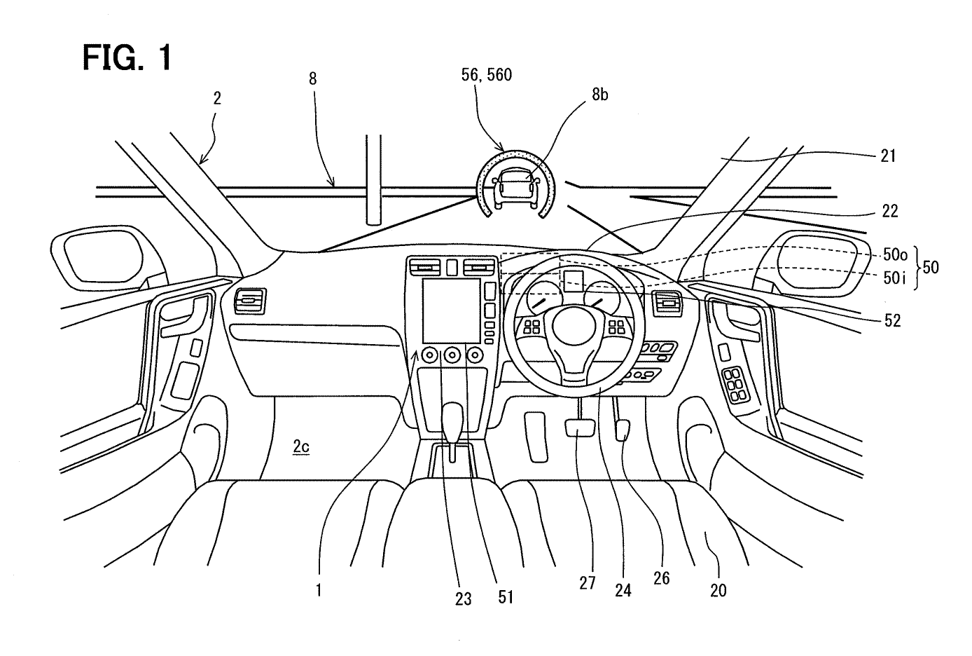

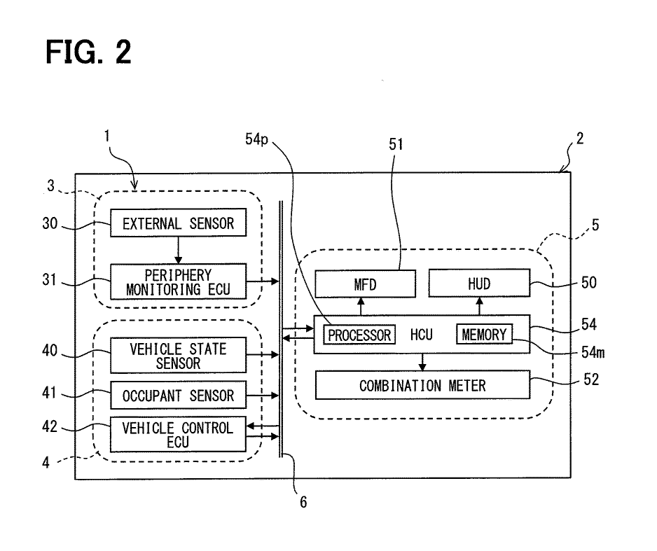

A travel assist system 1 of a first embodiment to which the present disclosure is applied is mounted on a subject vehicle 2 as illustrated in FIGS. 1 and 2.

As illustrated in FIG. 2, the travel assist system 1 includes a periphery monitoring system 3, a vehicle control system 4, and a display system 5. These systems 3, 4, 5 of the travel assist system 1 are connected through an in-vehicle network 6 such as a local area network (LAN).

The periphery monitoring system 3 is provided with an external sensor 30 and a periphery monitoring electronic control unit (ECU) 31. The external sensor 30 detects, for example, another vehicle, an artificial structure, a human and an animal, or a traffic sign present outside, as an obstacle that is present outside the subject vehicle 2 and may collide with the subject vehicle 2. The external sensor 30 includes, for example, one or more kinds selected from a sonar, a radar, and a camera.

Specifically, the sonar is an ultrasonic sensor that is installed, for example, in a front part or a rear part of the subject vehicle 2. The sonar receives reflected waves of ultrasonic waves transmitted to a detection area outside the subject vehicle 2 to detect an obstacle within the detection area, and thereby outputs a detection signal. The radar is a millimeter wave sensor or a laser sensor that is installed, for example, in the front part or the rear part of the subject vehicle 2. The radar receives reflected waves of millimeter or submillimeter waves or laser beams transmitted to the detection area outside the subject vehicle 2 to detect an obstacle within the detection area, and thereby outputs a detection signal. The camera is a monocular or compound-eye camera that is installed, for example, in a rearview mirror or a door mirror of the subject vehicle 2. The camera captures an image of the detection area outside the subject vehicle 2 to detect an obstacle or a traffic sign within the detection area, and thereby outputs an image signal.

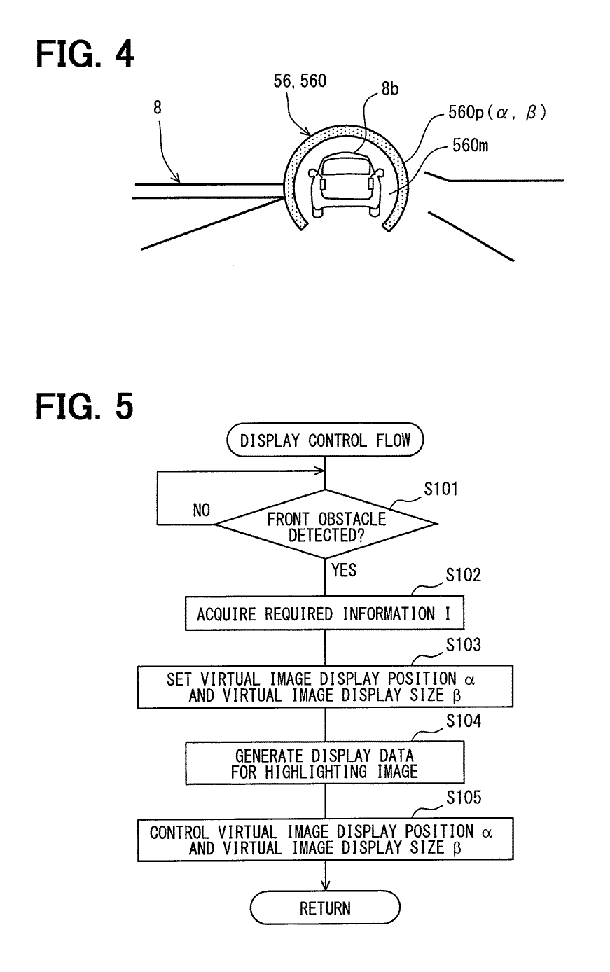

The periphery monitoring ECU 31 mainly includes a microcomputer including a processor and a memory, and is connected to the external sensor 30 and the in-vehicle network 6. The periphery monitoring ECU 31 acquires, for example, sign information such as speed limit sign and a lane sign and line marking information such as a white line and a yellow line on the basis of an output signal of the external sensor 30. In addition, the periphery monitoring ECU 31 acquires, for example, obstacle information such as the type of an obstacle, a moving direction and a moving speed of a front obstacle 8b (see FIGS. 1 and 4), and a relative speed and a relative distance of the front obstacle 8b with respect to the subject vehicle 2, on the basis of an output signal of the external sensor 30.

The vehicle control system 4 is provided with a vehicle state sensor 40, an occupant sensor 41, and a vehicle control ECU 42. The vehicle state sensor 40 is connected to the in-vehicle network 6. The vehicle state sensor 40 detects a traveling state of the subject vehicle 2. The vehicle state sensor 40 includes, for example, one or more kinds selected from a vehicle speed sensor, an engine speed sensor, a steering angle sensor, a fuel sensor, a water temperature sensor, and a radio receiver.

Specifically, the vehicle speed sensor detects a vehicle speed of the subject vehicle 2 and thereby outputs a vehicle speed signal corresponding to the detection. The engine speed sensor detests an engine speed in the subject vehicle 2 and thereby outputs an engine speed signal corresponding to the detection. The steering angle sensor detects a steering angle of the subject vehicle 2 and thereby outputs a steering angle signal corresponding to the detection. The fuel sensor detects a remaining fuel amount in a fuel tank of the subject vehicle 2 and thereby outputs a fuel signal corresponding to the detection. The water temperature sensor detects a cooling water temperature in an internal combustion engine in the subject vehicle 2 and thereby outputs a water temperature signal corresponding to the detection. The radio receiver receives, for example, output radio waves from a positioning satellite, a transmitter of another vehicle for vehicle-vehicle communication, and a roadside machine for road-vehicle communication, and thereby outputs a traffic signal. The traffic signal is, for example, a signal representing traffic information relating to the subject vehicle 2 such as a traveling position, a traveling direction, a traveling road state, and a speed limit and a signal representing the above obstacle information.

The occupant sensor 41 is connected to the in-vehicle network 6. The occupant sensor 41 detects a state or an operation of a user inside a vehicle cabin 2c of the subject vehicle 2 illustrated in FIG. 1. The occupant sensor 41 includes, for example, one or more kinds selected from a power switch, a user state monitor, a display setting switch, a turn switch, a cruise control switch, and a lane control switch.

Specifically, the power switch is turned on by a user inside the vehicle cabin 2c for starting the internal combustion engine or a motor generator of the subject vehicle 2 and thereby outputs a power signal corresponding to the turn-on operation. The user state monitor captures an image of a state of a user on a driver's seat 20 inside the vehicle cabin 2c using an image sensor to detect the user state and thereby outputs an image signal. The display setting switch is operated by a user for setting a display state inside the vehicle cabin 2c and thereby outputs a display setting signal corresponding to the operation. The turn switch is turned on by a user inside the vehicle cabin 2c for actuating a direction indicator of the subject vehicle 2 and thereby outputs a turn signal corresponding to the turn-on operation.

The cruise control switch is turned on by a user inside the vehicle cabin 2c for automatically controlling the following distance of the subject vehicle 2 with respect to a preceding vehicle as the front obstacle 8b or the vehicle speed of the subject vehicle 2 and thereby outputs a cruise control signal corresponding to the turn-on operation. The lane control switch is turned on by a user inside the vehicle cabin 2c for automatically controlling a width-direction position of the subject vehicle 2 in a traveling lane and thereby outputs a lane control signal corresponding to the turn-on operation.

The vehicle control ECU 42 illustrated in FIG. 2 mainly includes a microcomputer including a processor and a memory, and is connected to the in-vehicle network 6. The vehicle control ECU 42 includes one or more kinds of

ECUs selected from an engine control ECU, a motor control ECU, a brake control ECU, a steering control ECU, and an integrated control ECU, and includes at least the integrated control ECU.

Specifically, the engine control ECU controls actuation of a throttle actuator and a fuel injection valve of the internal combustion engine in accordance with an operation of an acceleration pedal 26 inside the vehicle cabin 2c illustrated in FIG. 1 or automatically to increase or reduce the vehicle speed of the subject vehicle 2. The motor control ECU controls actuation of the motor generator in accordance with an operation of the acceleration pedal 26 inside the vehicle cabin 2c or automatically to increase or reduce the vehicle speed of the subject vehicle 2. The brake control ECU controls actuation of a brake actuator in accordance with an operation of a brake pedal 27 inside the vehicle cabin 2c or automatically to increase or reduce the vehicle speed of the subject vehicle 2. The steering control ECU controls actuation of an electric power steering automatically in accordance with an operation of a steering wheel 24 inside the vehicle cabin 2c to adjust the steering angle of the subject vehicle 2. The integrated control ECU synchronously controls actuations of the other control ECUs in the vehicle control ECU 42 on the basis of, for example, control information in the other control ECUs, output signals of the sensors 40, 41, and acquired information in the periphery monitoring ECU 31.

In particular, the integrated control ECU of the present embodiment performs full speed range adaptive cruise control (FSRA) for automatically controlling the following distance and the vehicle speed of the subject vehicle 2 in a full speed range when the cruise control switch is turned on. The integrated control ECU mounted on the subject vehicle 2 as a “following distance control unit” that performs the FSRA controls actuation of the engine control ECU or the motor control ECU and actuation of the brake control ECU on the basis of acquired information in the periphery monitoring ECU 31 and an output signal of the radio receiver.

The integrated control ECU of the present embodiment performs lane keeping assist (LKA) for restricting a departure of the subject vehicle 2 from the white line or the yellow line to automatically control the width-direction position in the traveling lane when the lane control switch is turned on. The integrated control ECU mounted on the subject vehicle 2 also as a “lane control unit” that performs LKA controls actuation of the steering control ECU on the basis of acquired information in the periphery monitoring ECU 31 and an output signal of the radio receiver.

The display system 5 as a “vehicle display unit” is mounted on the subject vehicle 2 for visually presenting information. The display system 5 is provided with an HUD 50, a multi-function display (MFD) 51, a combination meter 52, and a human machine interface (HMI) control unit (HCU) 54.

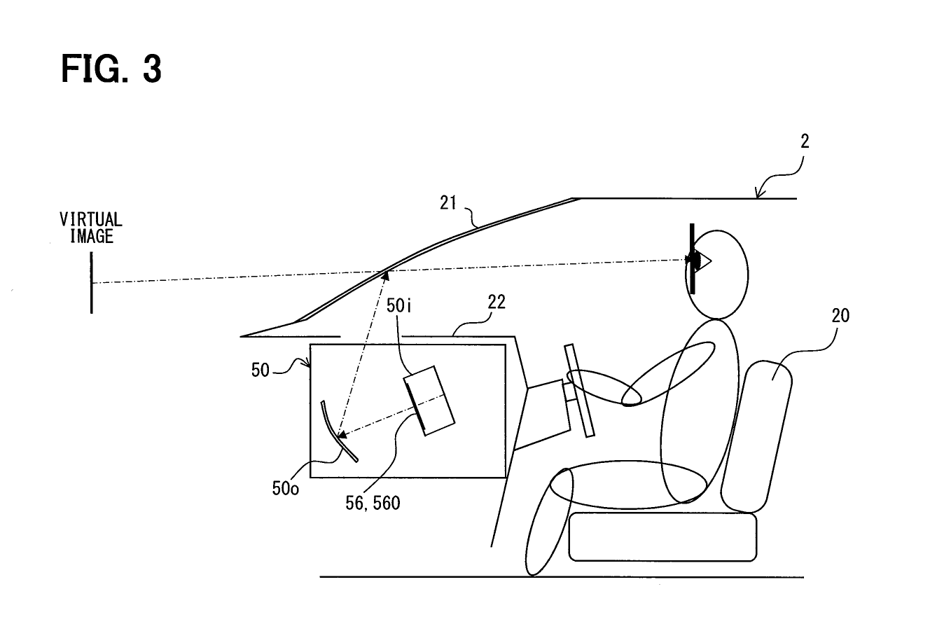

The HUD 50 is installed in an instrument panel 22 inside the vehicle cabin 2c illustrated in FIGS. 1 and 3. The HUD 50 projects a display image 56 formed so as to represent predetermined information by a display device 50i such as a liquid crystal panel or a projector with respect to a front windshield 21 as a “projection member” in the subject vehicle 2 through an optical system 50o. The front windshield 21 is formed of light transmissive glass so as to transmit outside scenery 8 which is present in front of the subject vehicle 2 outside the vehicle cabin 2c therethrough. At this time, a light beam of the display image 56 reflected by the front windshield 21 and a light beam from the outside scenery 8 transmitted through the windshield 21 are perceived by a user on the driver's seat 20. As a result, a virtual image of the display image 56 formed in front of the front windshield 21 is superimposed on part of the outside scenery 8, so that the virtual image of the display image 56 and the outside scenery 8 can be visually recognized by the user on the driver's seat 20.

As illustrated in FIG. 4, in the present embodiment, a highlighting image 560 as the display image 56 is virtually displayed to highlight the front obstacle 8b in the outside scenery 8. Specifically, the highlighting image 560 is formed as a linear portion 560p that curvedly extends in a circular arc shape at a virtual image display position α and has a constant width as a whole. A virtual image display size β of the linear portion 560p is variably set so as to continuously surround the front obstacle 8b at the virtual image display position α corresponding to the entire range less than a circle except a lower side of the periphery of the front obstacle 8b. In addition, the virtual image display size β of the linear portion 560p is variably set so as to leave a margin 560m for allowing a user to directly visually recognize the outside scenery 8 except the front obstacle 8b between the linear portion 560p and the front obstacle 8b on the inner peripheral side. A virtual image display color of the linear portion 560p is fixedly set or variably set by a user to a translucent color that enables a superimposed part with the outside scenery 8 to be visually recognized and also enables reduction in inconvenience to a user as well as a predetermined high-brightness color tone that highlights the front obstacle 8b to enable user's attention to be called thereto. For example, the virtual image display color of the linear portion 560p is set to light yellow, light red, light green, or light amber.

In addition to such display of the highlighting image 560, for example, display of an image representing one or more kinds of information selected from navigation information, sign information, and obstacle information may be employed as virtual image display by the HUD 50. Further, virtual image display can be achieved also by using a light transmissive combiner disposed on the instrument panel 22 and transmits the outside scenery 8 therethrough in cooperation with the windshield 21 to project the display image 56 on the combiner. The above navigation information can be acquired, for example, in the HCU 54 (described in detail below) on the basis of map information stored in a memory 54m and an output signal of the sensor 40.

The MFD 51 is installed in a center console 23 inside the vehicle cabin 2c illustrated in FIG. 1. The MFD 51 displays a real image of an image formed to represent predetermined information in one or more liquid crystal panels so as to be visually recognizable by a user on the driver's seat 20. Display of an image representing one or more kinds of information selected from navigation information, audio information, video information, and communication information is employed as such real image display by the MFD 51.

The combination meter 52 is installed in the instrument panel 22 inside the vehicle cabin 2c. The combination meter 52 displays vehicle information relating to the subject vehicle 2 so as to be visually recognizable by a user on the driver's seat 20. The combination meter 52 is a digital meter that displays vehicle information as an image formed on a liquid crystal panel or an analog meter that displays vehicle information by indicating scales by an indicator. For example, display representing one or more kinds of information selected from the vehicle speed, the engine speed, the remaining fuel amount, the cooling water temperature, and an operation state of the turn switch, the cruise control switch and the lane control switch is employed as such display by the combination meter 52.

The HCU 54 illustrated in FIG. 2 mainly includes a microcomputer including a processor 54p and the memory 54m, and is connected to the display elements 50, 51, 52 of the display system 5 and the in-vehicle network 6. The HCU 54 synchronously controls actuations of the display elements 50, 51, 52. At this time, the HCU 54 executes these actuation controls on the basis of, for example, output signals of the sensors 40, 41, acquired information in the ECU 31, control information in the ECU 42, information stored in the memory 54m, and acquired information in the HCU 54 itself. Each of the memory 54m of the HCU 54 and memories of the other various ECUs is configured using one or more kinds selected from storage media such as a semiconductor memory, a magnetic medium, and an optical medium.

In particular, in the present embodiment, data of the display image 56 including the highlighting image 560 is stored in the memory 54m as an “image storage device”, so that the HCU 54 functions as a “vehicle display control device”. Specifically, the HCU 54 executes a display control program using the processor 54p to achieve a display control flow for reading the highlighting image 560 from the memory 54m and displaying the read highlighting image 560 as illustrated in FIG. 5. It is needless to say that the “image storage device” storing the display image 56 may be implemented by any one of the memories of the ECUs incorporated in the display elements 50, 51, 52 or a combination of a plurality of memories selected from these memories of the ECUs and the memory 54m of the HCU 54. The display control flow is started in response to a turn-on operation of the power switch of the occupant sensor 41 and ended in response to a turn-off operation of the power switch. Note that “S” in the display control flow indicates each step.

In S101 of the display control flow, it is determined whether one front obstacle 8b to be highlighted by the highlighting image 560 to call attention has been detected. Specifically, the determination in S101 is made on the basis of, for example, one or more kinds of information selected from obstacle information acquired by the periphery monitoring ECU 31 and obstacle information represented by an output signal of the radio receiver as the occupant sensor 41. While negative determination is made in S101, S101 is repeatedly executed. On the other hand, when positive determination is made in S101, a shift to S102 is made.

In the following S102, required information I for virtually displaying the highlighting image 560 is acquired. Specifically, the required information I includes, for example, one or more kinds selected from acquired information in the periphery monitoring ECU 31 and information based on output signals of the sensors 40, 41. Examples of the acquired information in the periphery monitoring ECU 31 include obstacle information. Examples of the information based on an output signal of the vehicle state sensor 40 include a vehicle speed represented by an output signal of the vehicle speed sensor and a steering angle represented by an output signal of the steering angle sensor. Examples of the information based on the occupant sensor 41 include a set value of a display state represented by an output signal of the display setting switch, a user state such as an eyeball state represented by an output signal of the user state monitor, and traffic information and obstacle information represented by an output signal of the radio receiver.

In the following S103, the virtual image display position α and the virtual image display size β of the highlighting image 560 are set on the basis of the required information I acquired in S102. Specifically, a fixation point or a fixation line obtained when a user fixes his/her eyes on the front obstacle 8b detected in S101 is first estimated on the basis of the required information I. Then, the virtual image display position α is set at the entire range less than a circle except the lower side with respect to the front obstacle 8b on the estimated fixation point or fixation line. Further, the virtual image display size β is set so as to form the linear portion 560p with the margin 560m left with respect to the front obstacle 8b.

In the following S104, display data for virtually displaying the highlighting image 560 with the virtual image display position α and the virtual image display size β set in S103 is generated. At this time, the display data is generated by applying image processing to data of the highlighting image 560 read from the memory 54m.

In the following S105, the display data generated in S104 is provided to the HUD 50 to form the highlighting image 560 by the display device 50i, thereby controlling the virtual image display position α and the virtual image display size β of the linear portion 560p. As a result, as illustrated in FIGS. 1 and 4, the highlighting image 560 is visually recognized with the virtual image display size β surrounding the front obstacle 8b with the margin 560m left by the linear portion 560p at the virtual image display position α corresponding to the entire range less than a circle except the lower side of the periphery of the front obstacle 8b. Thereafter, in the display control flow, a return to S101 is made. As a result, when negative determination is made in S101 immediately after the return, the virtual image display of the highlighting image 560 is finished.

In the first embodiment as described above, part of the HCU 54 that executes S101, S102, S103, S104, and S105 corresponds to a “virtual image display control device” constructed by the processor 54p.

### Action and Effect

The action and effect of the first embodiment described hereinabove will be described below.

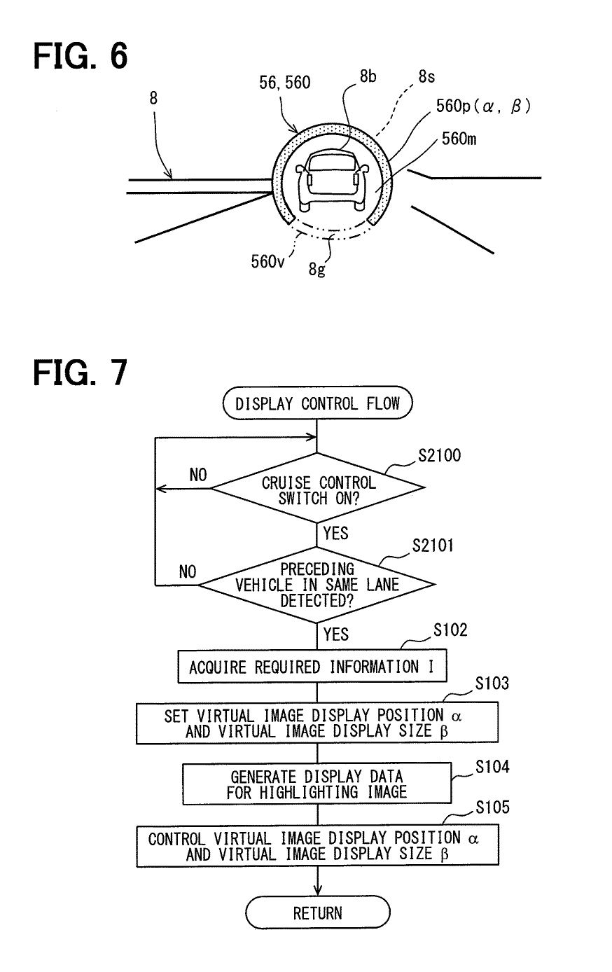

The highlighting image 560 that highlights the front obstacle 8b in the outside scenery 8 is controlled to the virtual image display size β surrounding the front obstacle 8b with the margin 560m left by the linear portion 560p at the virtual image display position α corresponding to the entire range less than a circle except the lower side of the periphery of the front obstacle 8b. Thus, as illustrated in FIG. 6, even if a user feels a deviation with respect to the front obstacle 8b, it looks as if the front obstacle 8b is pointed by the highlighting image 560 that is superimposed on a space 8s within the outside scenery 8 on the upper side, left side, and right side of the front obstacle 8b. Thus, the user is less likely to feel separation in the front-rear direction with respect to the front obstacle 8b.

Accordingly, even if the virtual image display position α of the highlighting image 560 deviates within a control error range, it is possible to maintain the association of the highlighting image 560 with the front obstacle 8b, and also possible to avoid the illusion as if the front obstacle 8b becomes separated. Further, even if the virtual image display position α of the highlighting image 560 deviates within the control error range, the margin 560m formed by the linear portion 560p prevents part of the front obstacle 8b from being hidden behind the highlighting image 560, which enables reduction in inconvenience to a user. As described above, the first embodiment that can achieve an inconvenience reducing action in addition to an association maintaining action and an illusion avoidance action makes it possible to appropriately highlight the front obstacle 8b by the virtual image display of the highlighting image 560.

As illustrated in FIG. 6, between the opposite ends of the linear portion 560p that extends in a circular arc shape at the virtual image display position α, a user can image a circular arc-shaped virtual linear portion 560v (refer to a chain double-dashed line in FIG. 6) that complements the linear portion 560p also under the front obstacle 8b. That is, a user can image the virtual linear portion 560v superimposed on ground 8g located under the front obstacle 8b. Thus, the virtual linear portion 560v is added, on the image, to the highlighting image 560 whose association with the ground 8g is weakened because the highlighting image 560 is not actually virtually displayed under the front obstacle 8b. Accordingly, it is possible to make the user less likely to feel separation in the front-rear direction of the highlighting image 560 with respect to the front obstacle 8b and, at the same time, enhance the association of the highlighting image 560 with the front obstacle 8b. As a result, it is possible to improve a highlighting effect for the front obstacle 8b.

As described above, since the virtual image display position α and the virtual image display size β of the highlighting image 560 displayed by the HUD 50 are controlled by the HCU 54, it is possible to appropriately highlight the front obstacle 8b by the highlighting image 560.

### Second Embodiment

A second embodiment of the present disclosure is a modification of the first embodiment. As illustrated in FIG. 7, in a display control flow of the second embodiment, it is determined whether the cruise control switch of the occupant sensor 41 is ON in S2100. As the result, while negative determination is made, S2100 is repeatedly executed. On the other hand, when positive determination is made, a shift to S2101 is made.

In S2101, it is determined whether one vehicle immediately ahead that travels in the same lane and in the same direction as the subject vehicle 2 has been detected as the front obstacle 8b under automatic following distance control by FSRA of the integrated control ECU in the vehicle control ECU 42. Specifically, the determination in S2101 is made on the basis of, for example, one or more kinds selected from control information of the integrated control ECU, obstacle information represented by an output signal of the radio receiver, and sign information, lane marking information and obstacle information acquired by the periphery monitoring ECU 31. While negative determination is made in S2101, a return to S2100 is made. On the other hand, when positive determination is made in S2101, a return to S2100 is made after the execution of S102, S103, S104, and S105. Note that when negative determination is made in S2100 or S2101 immediately after the return from S105, the virtual image display of the highlighting image 560 is finished.

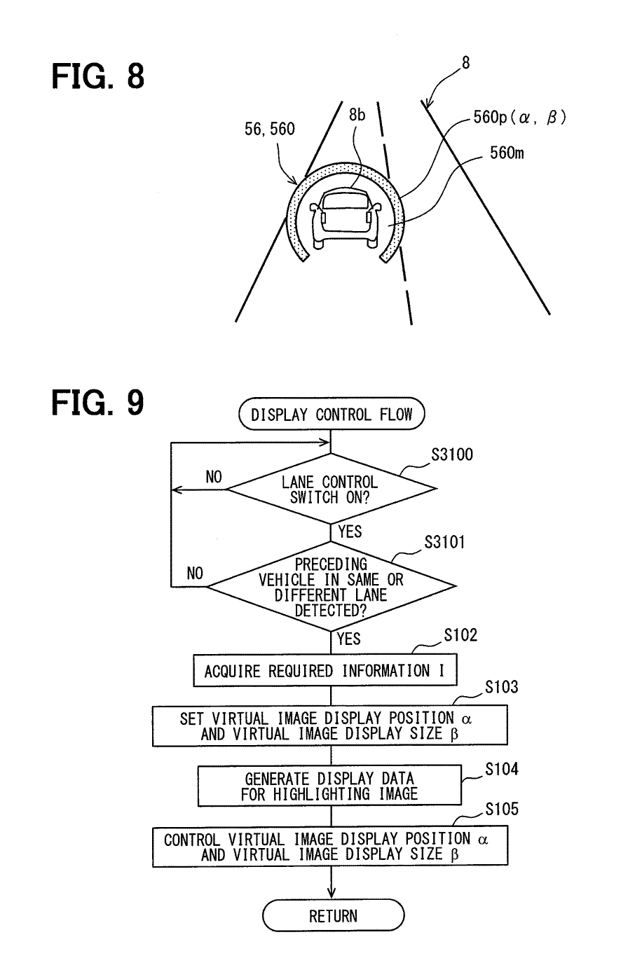

As described above, in the second embodiment, the following distance of the subject vehicle 2 with respect to a preceding vehicle as the front obstacle 8b is automatically controlled similarly to the first embodiment. Thus, the position α and the size β of the highlighting image 560 are controlled as illustrated in FIG. 8, which makes it possible to appropriately highlight the preceding vehicle in the same lane that requires the attention of a user under automatic control of the following distance to ensure the safety and security for a user. In the above second embodiment, part of the HCU 54 that executes S2100, S2101, S102, S103, S104, and S105 corresponds to the “virtual image display control device” constructed by the processor 54p.

### Third Embodiment

A third embodiment of the present disclosure is a modification of the first embodiment. As illustrated in FIG. 9, in a display control flow of the third embodiment, it is determined whether the lane control switch of the occupant sensor 41 is ON in S3100. As the result, while negative determination is made, S3100 is repeatedly executed. On the other hand, when positive determination is made, a shift to S3101 is made.

In S3101, it is determined whether one vehicle immediately ahead that travels in the same or a different lane and in the same direction as the subject vehicle 2 has been detected as the front obstacle 8b under automatic control by LKA of the integrated control ECU in the vehicle control ECU 42. Specifically, the determination in S3101 is made on the basis of, for example, one or more kinds selected from control information of the integrated control ECU, obstacle information represented by an output signal of the radio receiver, and sign information, lane marking information and obstacle information acquired by the periphery monitoring ECU 31. While negative determination is made in S3101, a return to S3100 is made. On the other hand, when positive determination is made in S3101, a return to S3100 is made after the execution of S102, S103, S104, and S105. Note that when negative determination is made in S3100 or S3101 immediately after the return from S105, the virtual image display of the highlighting image 560 is finished.

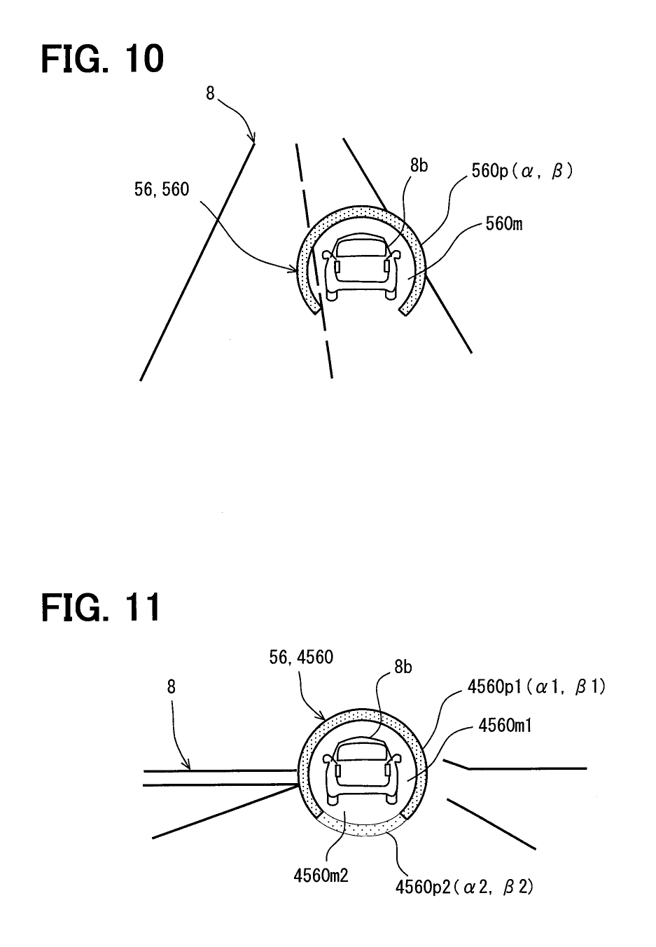

As described above, in the third embodiment, the width-direction position of the subject vehicle 2 in the traveling lane is automatically controlled similarly to the first embodiment. Thus, the position α and the size β of the highlighting image 560 are controlled as illustrated in FIG. 10, which makes it possible to appropriately highlight the preceding vehicle in the same or a different lane that requires the attention of a user under automatic control of the width-direction position to ensure the safety and security for a user. In the above third embodiment, part of the HCU 54 that executes S3100, S3101, S102, S103, S104, and S105 corresponds to the “virtual image display control device” constructed by the processor 54p.

### Fourth Embodiment

A fourth embodiment of the present disclosure is a modification of the first embodiment. As illustrated in FIG. 11, in the fourth embodiment, a highlighting image 4560 that differs from the highlighting image of the first embodiment is stored in the memory 54m and virtually displayed as the display image 56 that highlights the front obstacle 8b in the outside scenery 8. Specifically, the highlighting image 4560 includes a first linear portion 4560p1 that curvedly extends in a circular arc shape at a first virtual image display position α1 and a second linear portion 4560p2 that curvedly extends in a circular arc shape at a second virtual image display position α2. The first linear portion 4560p1 and the second linear portion 4560p2 are continuously formed with the same width. That is, the highlighting image 4560 has an annular linear shape as a whole.

A first virtual image display size β1 which is the size of the first linear portion 4560p1 is variably set so as to continuously surround the front obstacle 8b at the first virtual image display position α1 corresponding to the entire range less than a circle except a lower side of the periphery of the front obstacle 8b. In addition, the virtual image display size β1 of the first linear portion 4560p1 is variably set so as to leave a margin 4560m1 for allowing a user to directly visually recognize the outside scenery 8 except the front obstacle 8b between the first linear portion 4560p1 and the front obstacle 8b on the inner peripheral side. A virtual image display color of the first linear portion 4560p1 is fixedly set or variably set by a user to a translucent color that enables a superimposed part with the outside scenery 8 to be visually recognized and also enables reduction in inconvenience as well as a predetermined high-brightness color tone that highlights the front obstacle 8b to enable user's attention to be called to the front obstacle 8b. For example, the virtual image display color of the first linear portion 4560p1 is set to light yellow, light red, light green, or light amber.

On the other hand, a second virtual image display size β2 which is the size of the second linear portion 4560p2 is variably set so as to continuously surround the front obstacle 8b at the second virtual image display position α2 between the opposite ends of the first linear portion 4560p1 at the lower side of the periphery of the front obstacle 8b. In addition, the virtual image display size 131 of the second linear portion 4560p2 is variably set so as to leave a margin 4560m2 for allowing a user to directly visually recognize the outside scenery 8 except the front obstacle 8b between the second linear portion 4560p2 and the front obstacle 8b on the inner peripheral side. A virtual image display color of the second linear portion 4560p2 is fixedly set or variably set by a user to a translucent color that enables a superimposed part with the outside scenery 8 to be visually recognized and also enables reduction in inconvenience as well as a predetermined color tone having a lower brightness than the first linear portion 4560p1. For example, the virtual image display color of the second linear portion 4560p2 is set to dark yellow, dark red, dark green, or dark amber. The color tones of the respective linear portions 4560p1, 4560p2 may be set to similar color tones or dissimilar color tones. The brightness of the linear portion 4560p1 and the brightness of the linear portion 4560p2 are adjusted by setting gradation values of the respective linear portions 4560p1, 4560p2 so as to make a brightness value of a brightness signal lower at the second linear portion 4560p2 than that at the first linear portion 4560p1.

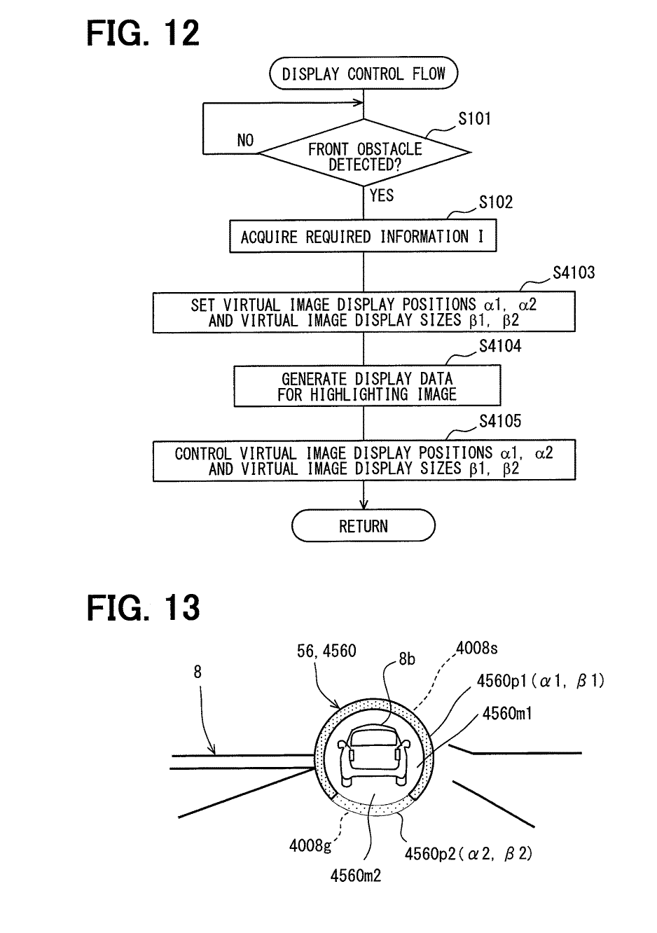

As illustrated in FIG. 12, in a display control flow of the fourth embodiment, in S4103 after the execution of S101 and S102 similar to the first embodiment, the virtual image display positions α1, α2 and the virtual image display sizes β1, β2 of the highlighting image 560 are set on the basis of required information I acquired in S102. Specifically, a fixation point or a fixation line obtained when a user fixes his/her eyes on the front obstacle 8b detected in S101 is first estimated on the basis of the required information I. Then, the first virtual image display position α1 is set at the entire range except the lower side with respect to the front obstacle 8b on the estimated fixation point or fixation line. Further, the first virtual image display size β1 is set so as to form the first linear portion 4560p1 with the margin 4560m1 left with respect to the front obstacle 8b. At the same time, the second virtual image display position α2 is set between the opposite ends of the first linear portion 4560p1 under the front obstacle 8b on the estimated fixation point or fixation line. Further, the second virtual image display size β2 is set so as to form the second linear portion 4560p2 with the margin 4560m2 left with respect to the front obstacle 8b.

In the following S4104, display data for virtually displaying the linear portions 4560p1, 4560p2 with the virtual image display positions α1, α2 and the virtual image display sizes β1, β2 set in S4103 is generated. At this time, the display data is generated by applying image processing to data of the highlighting image 4560 read from the memory 54m.

In the following S4105, the display data generated in S4104 is provided to the HUD 50 to form the highlighting image 4560 by the display device 50i, thereby controlling the virtual image display positions α1, α2 and the virtual image display sizes β1, β2 of the linear portions 4560p1, 4560p2. As a result, the highlighting image 4560 is visually recognized with the first virtual image display size β1 surrounding the front obstacle 8b with the margin 4560m1 left by the first linear portion 4560p1 at the first virtual image display position α1 corresponding to the entire range less than a circle except the lower side of the periphery of the front obstacle 8b. In addition, the highlighting image 4560 is visually recognized with the second virtual image display size β2 surrounding the front obstacle 8b with the margin 4560m2 left by the second linear portion 4560p2 having a lower brightness than the first linear portion 4560p1 at the second virtual image display position α2 corresponding to the lower side of the periphery of the front obstacle 8b. Thereafter, in the display control flow, a return to S101 is made. When negative determination is made in S101 immediately after the return, the virtual image display of the highlighting image 4560 is finished.

In the fourth embodiment as described above, part of the HCU 54 that executes S101, S102, S4103, S4104, and S4105 corresponds to the “virtual image display control device” constructed by the processor 54p.

### Action and Effect

The action and effect of the fourth embodiment described hereinabove will be described below.

The highlighting image 4560 that highlights the front obstacle 8b is controlled to the virtual image display size β1 surrounding the front obstacle 8b with the margin 4560m1 left by the first linear portion 4560p1 at the first virtual image display position α1 corresponding to the entire range less than a circle except the lower side of the periphery of the front obstacle 8b. Thus, as illustrated in FIG. 13, even if a user feels a deviation with respect to the front obstacle 8b, it looks as if the front obstacle 8b is pointed by the first linear portion 4560p1 that is superimposed on a space 4008s within the outside scenery 8 on the upper side, left side, and right side of the front obstacle 8b. Thus, the user is less likely to feel separation in the front-rear direction with respect to the front obstacle 8b.

Further, the highlighting image 4560 is controlled to the virtual image display size β2 surrounding the front obstacle 8b with the margin 4560m2 left by the second linear portion 4560p2 at the second virtual image display position α2 corresponding a part of the periphery of the front obstacle 8b between the opposite ends of the first linear portion 4560p1. As illustrated in FIG. 13, even when the second linear portion 4560p2 having a lower brightness than the first linear portion 4560p1 is superimposed on ground 4008g which is present under the front obstacle 8b, the fixation point of a user is likely to be more focused onto the first linear portion 4560p1 than the second linear portion 4560p2. Thus, the second linear portion 4560p2 having a lower brightness weakens the association with the ground 4008g. Accordingly, the user is less likely to feel separation in the front-rear direction with respect to the front obstacle 8b.

Accordingly, even if the virtual image display positions α1, α2 of the linear portions 4560p1, 4560p2 deviate within a control error range, it is possible to maintain the association of the highlighting image 4560 with the front obstacle 8b, and also possible to avoid the illusion as if the front obstacle 8b becomes separated. Further, even if the virtual image display positions α1, α2 of the linear portions 4560p1, 4560p2 deviate within the control error range, the margins 4560m1, 4560m2 formed by the linear portions 4560p1, 4560p2 prevent part of the front obstacle 8b from being hidden behind the highlighting image 4560, which enables reduction in inconvenience to a user to be reduced. As described above, the fourth embodiment that can achieve an inconvenience reducing action in addition to an association maintaining action and an illusion avoidance action makes it possible to appropriately highlight the front obstacle 8b by the virtual image display of the highlighting image 4560.

Further, even when the second linear portion 4560p2 that curvedly extends between the opposite ends of the first linear portion 4560p1 at the second virtual image display position α2 is superimposed on the ground 4008g, not only the fixation point of a user is less likely to be focused thereon due to a low brightness thereof, but also the user is less likely recall the horizontal line. Thus, when the virtual image display positions α1, α2 of the linear portions 4560p1, 4560p2 deviate within the control error range, the association of the second linear portion 4560p2 with the ground 4008g is weakened even at the lower side of the front obstacle 8b, and it is thus possible to divert the fixation point from the second linear portion 4560p2. Accordingly, it is possible to reliably exhibit the association maintaining action and the illusion avoidance action. Thus, the front obstacle 8b can be appropriately highlighted.

As described above, since the virtual image display positions α1, α2 and the virtual image display sizes β1, β2 of the highlighting image 4560 displayed by the HUD 50 are controlled by the HCU 54, it is possible to appropriately highlight the front obstacle 8b by the highlighting image 4560.

### Fifth Embodiment

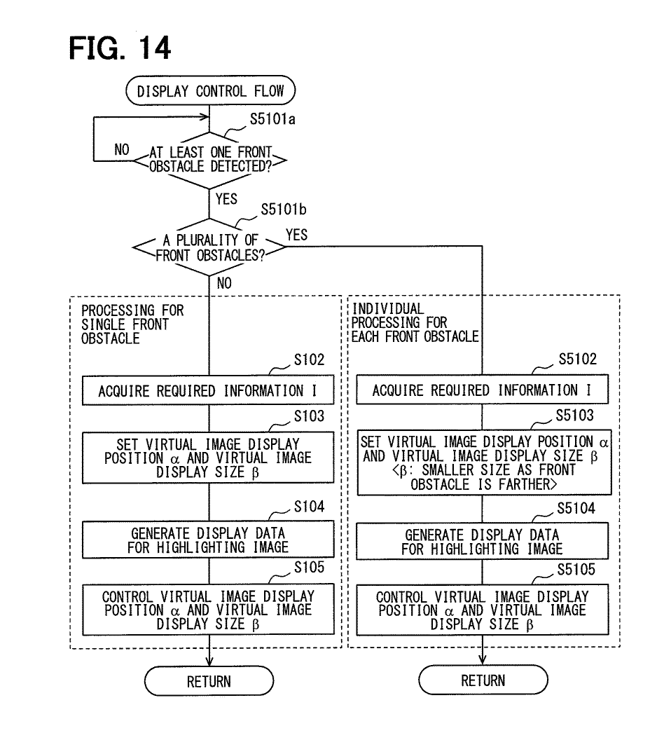

A fifth embodiment of the present disclosure is a modification of the first embodiment. As illustrated in FIG. 14, in a display control flow of the fifth embodiment, S5101a and S5101b are executed instead of S101.

In S5101a, it is determined whether at least one front obstacle 8b to be highlighted by the highlighting image 560 to call attention has been detected. The determination at this time is made in the same manner as S101. While negative determination is made in S5101a, S5101a is repeatedly executed. On the other hand, when positive determination is made in S5101a, a shift to S5101b is made.

In S5101b, it is determined whether a plurality of front obstacles 8b have been detected in S101. As the result, when negative determination is made, S102, S103, S104, and S105 are executed as processing for the single front obstacle 8b. On the other hand, when positive determination is made, S5102, S5103, S5104, and S5105 are executed as individual processing for each of the front obstacles 8b.

In S5102, required information I for virtually displaying the highlighting image 560 is individually acquired for each front obstacle 8b detected in S101. At this time, the required information I for each front obstacles 8b is acquired in the same manner as in S102.

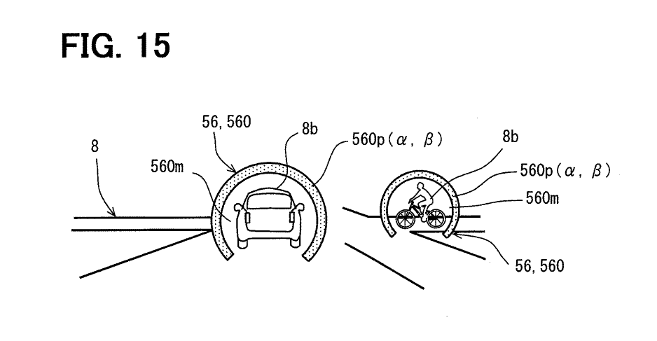

In the following S5103, the virtual image display position α and the virtual image display size β of the highlighting image 560 are individually set for each front obstacles 8b detected in S101. At this time, based on the required information I for each front obstacle 8b acquired in S5102, the virtual image display size β is set to be smaller as the front obstacle 8b to be highlighted by the highlighting image 560 is farther from the subject vehicle 2 as illustrated in FIG. 15. The virtual image display position α and the virtual image display size β are set in the same manner as S103 in the other points.

In the following S5104, as illustrated in FIG. 14, display data for virtually displaying the highlighting image 560 with the virtual image display position α and the virtual image display size β set in S5103 is individually generated for each front obstacle 8b detected in S101. At this time, the display data for each front obstacle 8b is generated in the same manner as 5104.

In the following S5105, the display data generated in S5104 is provided to the HUD 50 to form the highlighting image 560 by the display device 50i. Accordingly, the virtual image display position α and the virtual image display size β of the linear portion 560p of the highlighting image 560 are individually controlled for each front obstacle 8b detected in S101. As a result, as illustrated in FIG. 15, each highlighting image 560 for each front obstacle 8b is visually recognized with the virtual image display size β that becomes smaller as the front obstacle 8b to be highlighted by the highlighting image 560 is farther from the subject vehicle 2 in addition to the virtual image display size β at the virtual image display position α similar to S105.

In the display control flow, a return to S5101a is made after the execution of S5105. When negative determination is made in S5101a immediately after the return, virtual image display of all the highlighting images 560 is finished. When positive determination is made in S5101a immediately after the return and negative determination is made in S5101b, virtual image display of the highlighting image 560 for the front obstacle 8b that becomes undetected is finished, but virtual image display of the highlighting image 560 for the front obstacle 8b that remains detected is continued. Note that a return to S5101a is made also after the execution of S105.

As described above, according to the fifth embodiment, the highlighting images 560 that individually highlight the plurality of front obstacles 8b are controlled to a smaller size as the front obstacle 8b to be highlighted is farther from the subject vehicle 2. Accordingly, it is possible to increase the degree of highlighting by the highlighting image 560 having a large size for the front obstacle 8b that is close to the subject vehicle 2 and thus requires particular attention and, at the same time, ensure a highlighting function by the highlighting image 560 having a small size also for the front obstacle 8b that is far from the subject vehicle 2. Thus, highlighting of the plurality of obstacles 8b by the respective highlighting images 560 can be appropriately performed in a prioritized manner. In the above fifth embodiment, part of the HCU 54 that executes S5101a, S5101b, S102, S103, S104, S105, S5102, S5103, S5104, and S5105 corresponds to the “virtual image display control device” constructed by the processor 54p.

### Sixth Embodiment

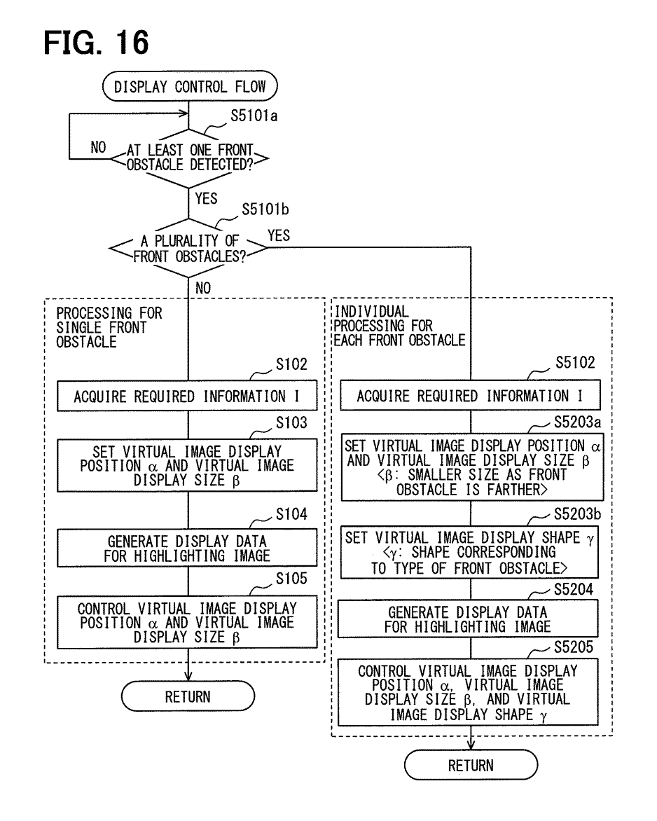

A sixth embodiment of the present disclosure is a modification of the fifth embodiment. As illustrated in FIG. 16, in a display control flow of the sixth embodiment, S5203a, S5203b, S5204, and S5205 are executed after the execution of S5102.

In S5203a, the virtual image display position α and the virtual image display size β of the highlighting image 560 are individually set for each front obstacle 8b detected in S101. At this time, the virtual image display position α and the virtual image display size β are set in the same manner as S5103.

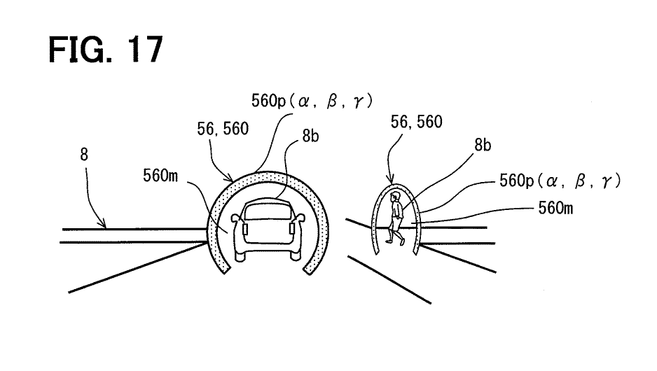

In the following S5203b, a virtual image display shape _{y} of the highlighting image 560 is individually set for each front obstacle detected in S101. At this time, as illustrated in FIG. 17, the virtual image display shapes γ of the linear portions 560p in the respective highlighting images 560 are varied according to the type of the front obstacle 8b as obstacle information in the required information I acquired in S5102. In the example of FIG. 17, the virtual image display shape γ of the linear portion 560p is set to a partial perfect circle as a circular arc with respect to the front obstacle 8b that is another vehicle. In addition, in the example of FIG. 17, the virtual image display shape γ of the linear portion 560p is set to a partial ellipse as a circular arc with respect to the front obstacle 8b that is a person.

In the following S5204, as illustrated in FIG. 16, display data for virtually displaying the highlighting image 560 with the virtual image display shape γ set in S5203b in addition to the virtual image display position α and the virtual image display size β set in S5203a is generated. At this time, the display data is individually generated for each front obstacle 8b detected in S101 by applying image processing to data of the highlighting image 560 read from the memory 54m in the same manner as S5104.

In the following S5205, the display data generated in S5204 is provided to the HUD 50 to form the highlighting image 560 by the display device 50i, thereby controlling the virtual image display position α, the virtual image display size β, and the virtual image display shape γ of the linear portion 560p. As a result, as illustrated in FIG. 17, each highlighting image 560 for each front obstacle 8b is visually recognized with the virtual image display shape γ which is varied according to the type of the front obstacle 8b to be highlighted in addition to the virtual image display position α and the virtual image display size β similar to S5105. In the display control flow, a return to S5101a is made after the execution of S5205.

As described above, according to the sixth embodiment, the virtual image display shapes γ of the highlighting images 560 that individually highlight the plurality of front obstacles 8b are varied according to the type of the front obstacle 8b to be highlighted. Accordingly, a user can determine the type of each front obstacle 8b from the virtual image display shape γ of the corresponding highlighting image 560. Thus, it is possible to enhance the association of the highlighting images 560 with the respective obstacles 8b to thereby appropriately highlight these obstacles 8b. In the above sixth embodiment, part of the HCU 54 that executes S5101a, S5101b, S102, S103, S104, S105, S5102, S5203a, S5203b, S5204, and S5205 corresponds to the “virtual image display control device” constructed by the processor 54p.

### Seventh Embodiment

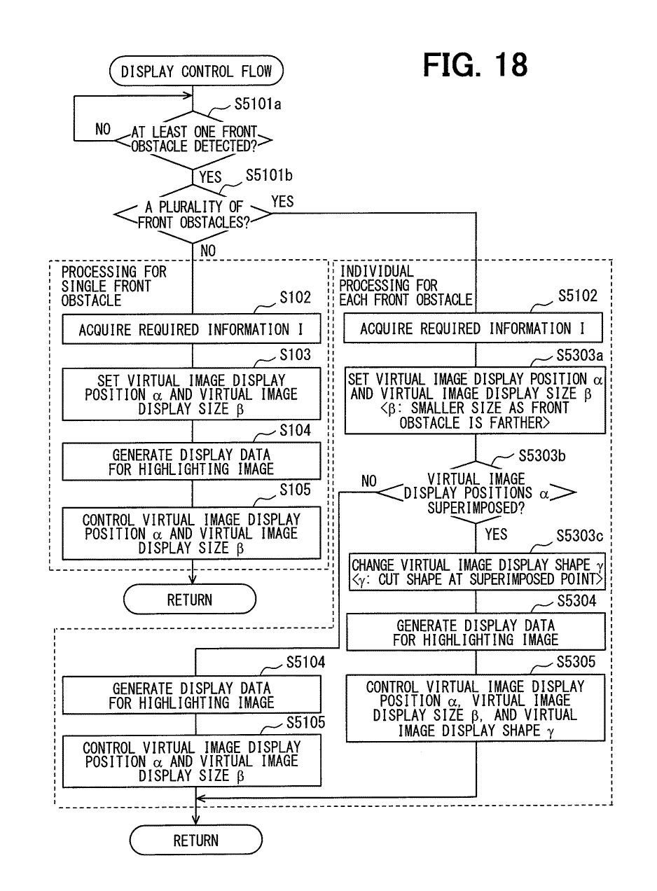

A seventh embodiment of the present disclosure is a modification of the fifth embodiment. As illustrated in FIG. 18, in a display control flow of the seventh embodiment, S5303a, S5303b, S5303c, S5304, S5305, S5104, and S5105 are executed after the execution of S5102.

In S5303a, the virtual image display position α and the virtual image display size β of the highlighting image 560 are individually set for each front obstacle 8b detected in S101. At this time, the virtual image display position α and the virtual image display size β are set in the same manner as in S5103.

For example, an intersection or a city area has many points that are desired to be closely watched by a user. Thus, in the following S5303b, it is determined whether virtual image display positions α of the highlighting images 560 set for the respective front obstacles 8b in S5303a are superimposed on one another. As the result, when positive determination is made, a shift to S5303c is made.

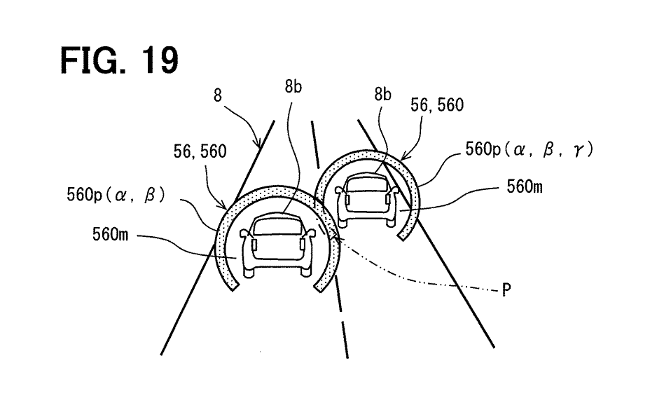

In S5303c, based on required information I acquired in S5102, the virtual image display shape γ is changed in one of the highlighting images 560 whose virtual image display positions α are superimposed as illustrated in FIG. 19, the one highlighting the front obstacle 8b farther from the subject vehicle 2. At this time, the virtual image display shape γ is set so as to cut the virtual image display of the linear portion 560p that highlights the front obstacle 8b farther from the subject vehicle 2 at a point P where the virtual image display positions α are superimposed. Note that, when the linear portion 560p that highlights the front obstacle 8b farther from the subject vehicle 2 is superimposed on the front obstacle 8b closer to the subject vehicle 2, the virtual image display shape γ may be set so as to cut the linear portion 560p also at this superimposed point.

In the following S5304, as illustrated in FIG. 18, display data for virtually displaying the highlighting image 560 with the virtual image display shape γ set in S5303b in addition to the virtual image display position α and the virtual image display size β set in S5303a is generated. At this time, the display data is individually generated for each front obstacle 8b detected in S101 by applying image processing to data of the highlighting image 560 read from the memory 54m in the same manner as in S5104.

In the following S5305, the display data generated in S5304 is provided to the HUD 50 to form the highlighting image 560 by the display device 50i, thereby controlling the virtual image display position α, the virtual image display size β, and the virtual image display shape γ of the linear portion 560p. As a result, as illustrated in FIG. 19, each highlighting image 560 for each front obstacle 8b is visually recognized with the virtual image display shape γ in which the virtual image display of the highlighting image 560 with respect to the front obstacle 8b farther from the subject vehicle 2 is cut at the superimposed point P in addition to the virtual image display position α and the virtual image display size β similar to S5105.

In the display control flow, a return to S5101a is made after the execution of S5305. On the other hand, when negative determination is made in S5303b, S5104 and S5105 described in the fifth embodiment are executed prior to the return to S5101a without the execution of S5303c, S5304, and S5305. In this case, each highlighting image 560 for each front obstacle 8b is visually recognized with the position α and the size β similar to S5105.

As described above, according to the seventh embodiment, when the virtual image display positions a of the highlighting images 560 that individually highlight the plurality of front obstacles 8b are superimposed on one another, the virtual image display of the highlighted image 560 that highlights the front obstacle 8b farther from the subject vehicle 2 is cut at the superimposed point P. Accordingly, it is possible to increase the degree of highlighting by the highlighting image 560 having no cut for the front obstacle 8b that is close to the subject vehicle 2 and thus requires particular attention and, at the same time, ensure a highlighting function also for the front obstacle 8b farther from the subject vehicle 2 by the cut highlighting image 560. Further, inconvenience to a user caused by the superimposed virtual image display positions α can be reduced. Thus, highlighting of the plurality of obstacles 8b by the respective highlighting images 560 can be appropriately performed in a prioritized manner. In the above seventh embodiment, part of the HCU 54 that executes S5101a, S5101b, S102, S103, S104, S105, S5102, S5303a, S5303b, S5303c, S5304, S5305, S5104, and S5105 corresponds to the “virtual image display control device” constructed by the processor 54p.

### Eighth Embodiment

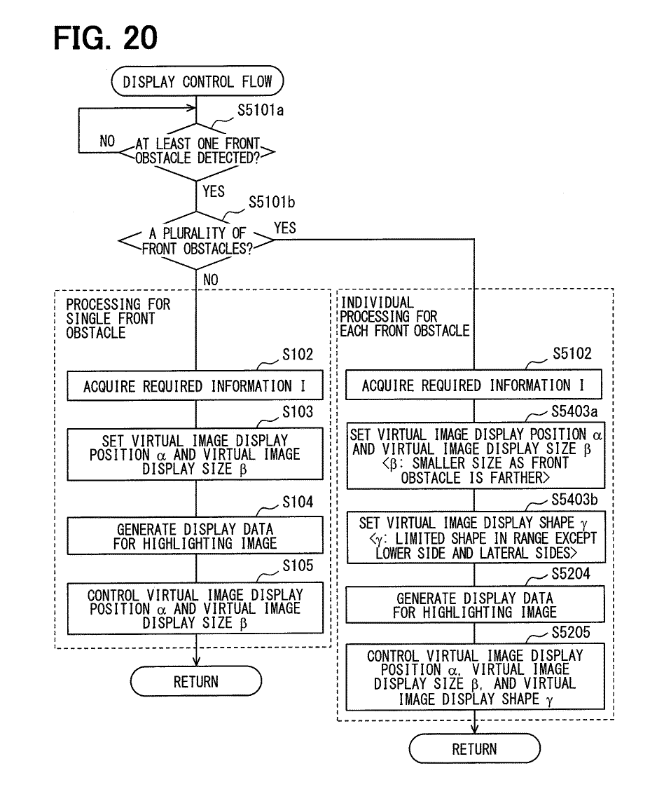

An eighth embodiment of the present disclosure is a modification of the sixth embodiment. As illustrated in FIG. 20, in a display control flow of the eighth embodiment, S5403a, S5403b, S5204, and S5205 are executed after the execution of S5102.

In S5403a, the virtual image display position α and the virtual image display size β of the highlighting image 560 are individually set for each front obstacle 8b detected in S101. At this time, the virtual image display position α and the virtual image display size β are set in the same manner as in S5103.

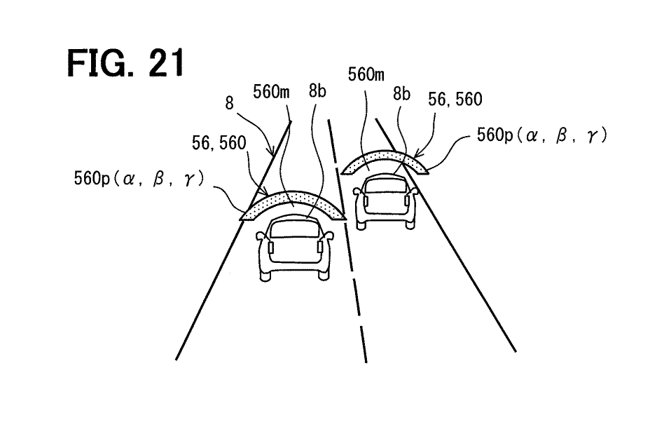

In the following S5403b, the virtual image display shape γ of the highlighting image 560 is individually set for each front obstacle 8b detected in S101. At this time, the virtual image display shape γ of each highlighting image 560 is set so as to limit a virtual image display range of the linear portion 560p to a range except both lateral sides in addition to the lower side in the periphery of the front obstacle 8b to be highlighted as illustrated in FIG. 21. That is, the virtual image display shape γ of each highlighting image 560 is set to a circular arc in which the linear portion 560p curvedly extends substantially only at the upper side of the periphery of the front obstacle 8b to be highlighted.

As illustrated in FIGS. 20, S5204 and S5205 described in the sixth embodiment are executed after the execution of S5403b. As a result, as illustrate in FIG. 21, each highlighting image 560 for each front obstacle 8b is visually recognized with the shape γ limiting the virtual image display of the linear portion 560p to the range except the lower side and the lateral sides in the periphery of the front obstacle 8b to be highlighted in addition to the position α and the size β similar to S5105.

As described above, according to the eighth embodiment, the virtual image display of each of the highlighting images 560 that individually highlights the plurality of front obstacles 8b is limited to the range except not only the lower side, but also the lateral sides in the periphery of the front obstacle 8b to be highlighted. This makes the virtual image display positions α of the highlighting images 560 corresponding to the respective obstacles 8b less likely to be superimposed on one other. Thus, it is possible not only to individually associating the highlighting images 560 with the respective obstacles 8b, but also to reduce inconvenience to a user caused by such superimposition. Therefore, it is possible to more appropriately highlight the plurality of obstacles 8b by the respective highlighting images 560. In the above eighth embodiment, part of the HCU 54 that executes S5101a, S5101b, S102, S103, S104, S105, S5102, S5403a, S5403b, S5204, and S5205 corresponds to the “virtual image display control device” constructed by the processor 54p.

### Ninth Embodiment

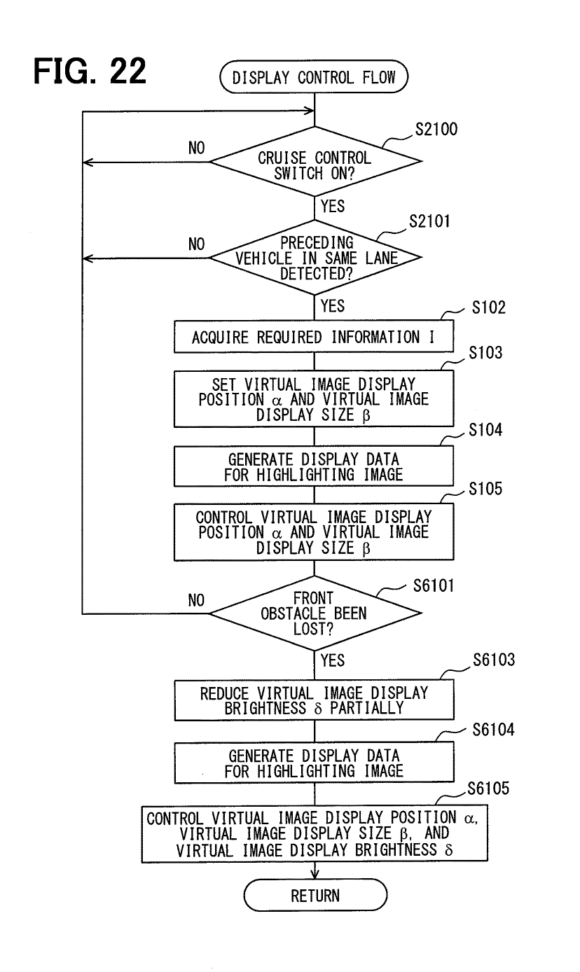

A ninth embodiment of the present disclosure is a modification of the second embodiment. As illustrated in FIG. 22, in a display control flow of the ninth embodiment, S6101, S6103, S6104, and S6105 are executed after the execution of S105.

In S6101, it is determined whether a preceding vehicle in the same lane as the front obstacle 8b once detected in S2101 has been lost under automatic following distance control by FSRA. It is assumed that the detection lost occurs not only when the preceding vehicle moves to a lane different from the lane of the subject vehicle 2 and thus becomes undetected, but also when the preceding vehicle erroneously becomes undetected by disturbance even when remaining in the same lane.

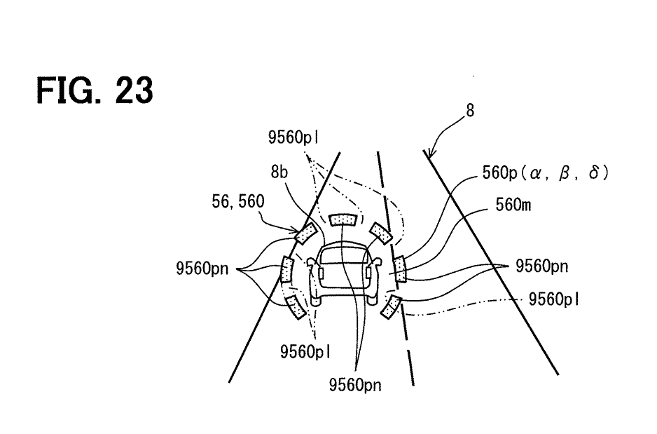

When negative determination is made in S6101, a return to S101 is made. When positive determination is made in S6101, a shift to S6103 is made. In S6103, as illustrated in FIG. 23, a virtual image display brightness δ of the highlighting image 560 is partially reduced. At this time, the virtual image display brightness δ is set so as to alternately form a normal brightness portion 9560pn and a low brightness portion 9560pl having a lower brightness than the normal brightness portion 9560pn for each predetermined length of the linear portion 560p. In the present embodiment, the virtual image display brightness δ is set in such a manner that the normal brightness portion 9560pn has the high brightness described in the first embodiment and the low brightness portion 9560pl has substantially zero brightness. In FIG. 23, the outer shape of only one low brightness portion 9560pl is virtually indicated by a chain double-dashed line, and the outer shapes of the other low brightness portions 9560pl are not illustrated. Note that the brightness of the low brightness portion 9560pl may be set to be higher than zero brightness as long as it is lower than the brightness of the normal brightness portion 9560pn.

In the following S6104, as illustrated in FIG. 22, display data for virtually displaying the highlighting image 560 with the virtual image display brightness δ set in S6101 in addition to the virtual image display position α and the virtual image display size β set in S103 is generated. At this time, the display data is generated by applying image processing to data of the highlighting image 560 read from the memory 54m in the same manner as in S104.

In the following S6105, the display data generated in S6104 is provided to the HUD 50 to form the highlighting image 560 by the display device 50i, thereby controlling the virtual image display position α, the virtual image display size β, and the virtual image display brightness δ of the linear portion 560p. As a result, as illustrated in FIG. 23, the highlighting image 560 is visually recognized as a broken line by the linear portion 560p whose virtual image display brightness δ is partially reduced in addition to the virtual image display position α and the virtual image display size β similar to S105. In the display control flow, a return to S2100 is made after the execution of S6105.

As described above, according to the ninth embodiment, when the front obstacle 8b once detected in the subject vehicle 2 has been lost, the virtual image display brightness δ of the highlighting image 560 that highlights the lost front obstacle 8b is partially reduced. Accordingly, even when a user can visually recognize the front obstacle 8b, the user can intuitively understand a detection lost state of the subject vehicle 2 from a change in the brightness of the highlighting image 560. Thus, it is possible to ensure the safety and security for a user using the highlighting image 560. In the above ninth embodiment, part of the HCU 54 that executes S2100, 52101, S102, S103, S104, S105, S6101, S6103, S6104, and S6105 corresponds to the “virtual image display control device” constructed by the processor 54p.

### Tenth Embodiment

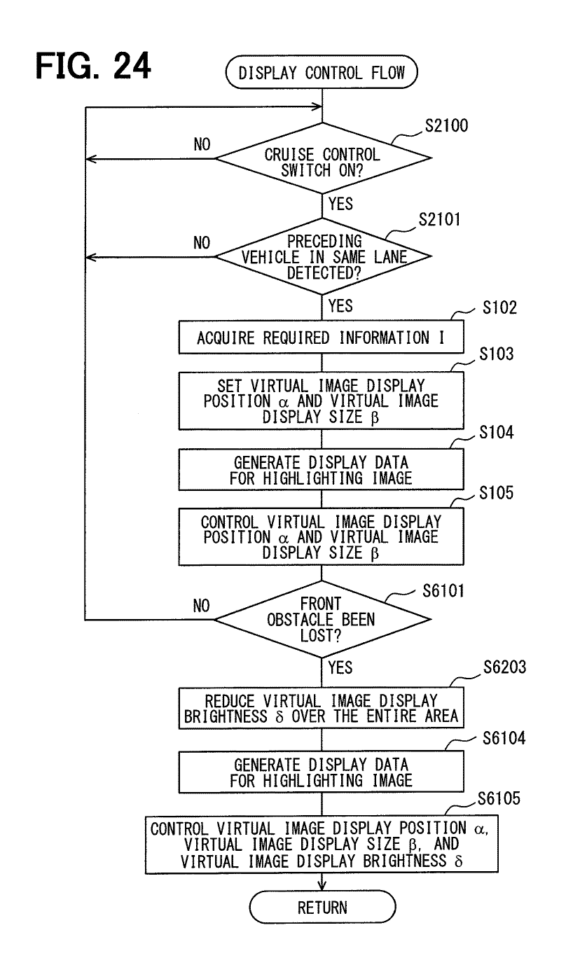

A tenth embodiment of the present disclosure is a modification of the ninth embodiment. As illustrated in FIG. 24, in a display control flow of the tenth embodiment, when positive determination is made in S6101, S6203, S6104, and S6105 are executed.

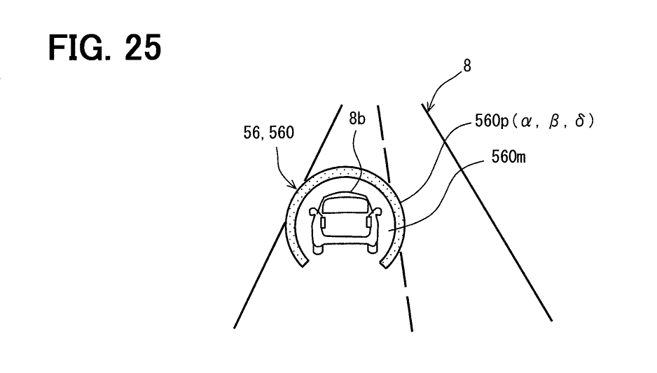

In S6203, as illustrated in FIG. 25, the virtual image display brightness δ of the highlighting image 560 is reduced over the entire area of the image 560. At this time, the virtual image display brightness δ is set in such a manner that the brightness of the entire linear portion 560p is lower than the high brightness described in the first embodiment and higher than the zero brightness. In FIG. 25, a reduction in the virtual image display brightness δ is schematically represented by making the roughness of dot-hatching rougher than that of FIG. 8 in the second embodiment.

In the display control flow, as illustrated in FIGS. 24, S6104 and S6105 described in the ninth embodiment are executed after the execution of S6203. As a result, the highlighting image 560 is visually recognized as the linear portion 560p whose virtual image display brightness δ is wholly reduced as illustrated in FIG. 25 in addition to visual recognition with the virtual image display position α and the virtual image display size β similar to S105.

As described above, according to the tenth embodiment, when the front obstacle 8b once detected in the subject vehicle 2 has been lost, the virtual image display brightness δ of the entire highlighting image 560 that highlights the lost front obstacle 8b is reduced. Accordingly, even when a user can visually recognize the front obstacle 8b, the user can intuitively understand a detection lost state of the subject vehicle 2 from a change in the brightness of the highlighting image 560. Thus, it is possible to ensure the safety and security for a user using the highlighting image 560. In the above ninth embodiment, part of the HCU 54 that executes S2100, S2101, S102, S103, S104, S105, S6101, S6203, S6104, and S6105 corresponds to the “virtual image display control device” constructed by the processor 54p.

### Eleventh Embodiment

An eleventh embodiment of the present disclosure is a modification of the second embodiment. The integrated control ECU in the vehicle control ECU 42 according to the eleventh embodiment performs adaptive cruise control (ACC) for forcibly and automatically controlling the following distance and the vehicle speed in a specific vehicle speed range such as a high speed range instead of FSRA. The integrated control ECU as an “automatic control unit” that performs ACC switches manual driving by a user to automatic control driving when the cruise control switch is turned on and the vehicle speed of the subject vehicle 2 falls within the specific vehicle speed range. On the other hand, the integrated control ECU switches automatic control driving to manual driving when the cruise control switch is turned off during the automatic control driving or when the vehicle speed falls outside the specific vehicle speed range during the automatic control driving.

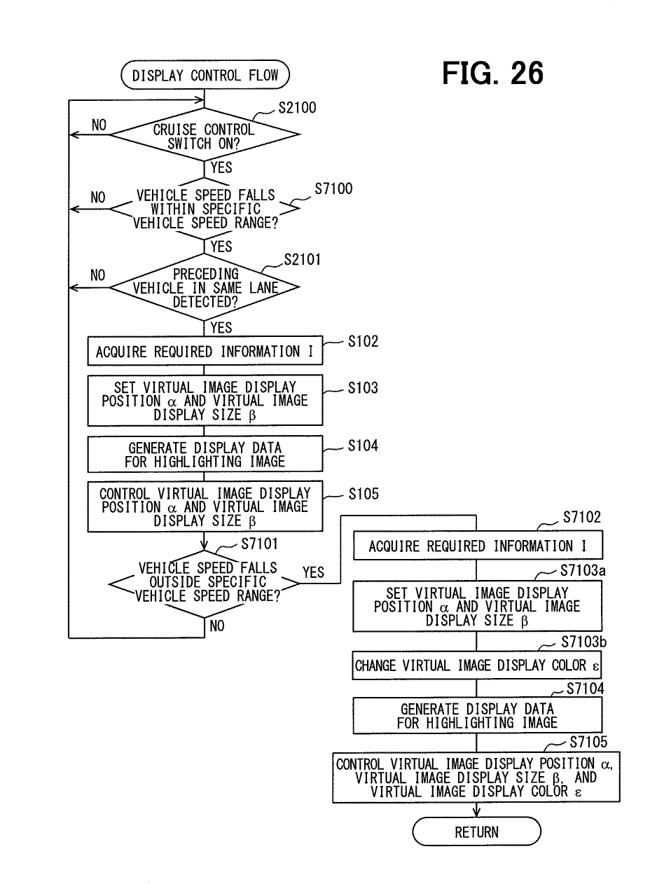

In the display control flow of the eleventh embodiment, as illustrated in FIG. 26, when positive determination is made in S2100, S7100 is executed.

In S7100, it is determined whether the vehicle speed of the subject vehicle 2 falls within the specific vehicle speed range on the basis of an output signal of the vehicle speed sensor of the vehicle state sensor 40. As the result, when negative determination is made, a return to S2100 is made. On the other hand, when positive determination is made, S7101, S7102, S7103a, S7103b, S7104, and S7105 are executed after the execution of S2101, S102, S103, S104, and S105.

In S7101, it is determined whether the vehicle speed falls outside the specific vehicle speed range on the basis of an output signal of the vehicle speed sensor. As the result, when negative determination is made due to the vehicle speed kept within the specific vehicle speed range, a return to S2100 is made. On the other hand, when positive determination is made due to the vehicle speed outside the specific vehicle speed range, a shift to S7102 is made along with automatic switching from the automatic control driving to the manual driving by the integrated control ECU.

In S7102, required information I for virtually displaying the highlighting image 560 is acquired in the same manner as S102. In the following S7103a, the virtual image display position α and the virtual image display size β of the highlighting image 560 are set on the basis of the required information I acquired in S7102. The virtual image display position α and the virtual image display size β are set in the same manner as S103 in the other points.

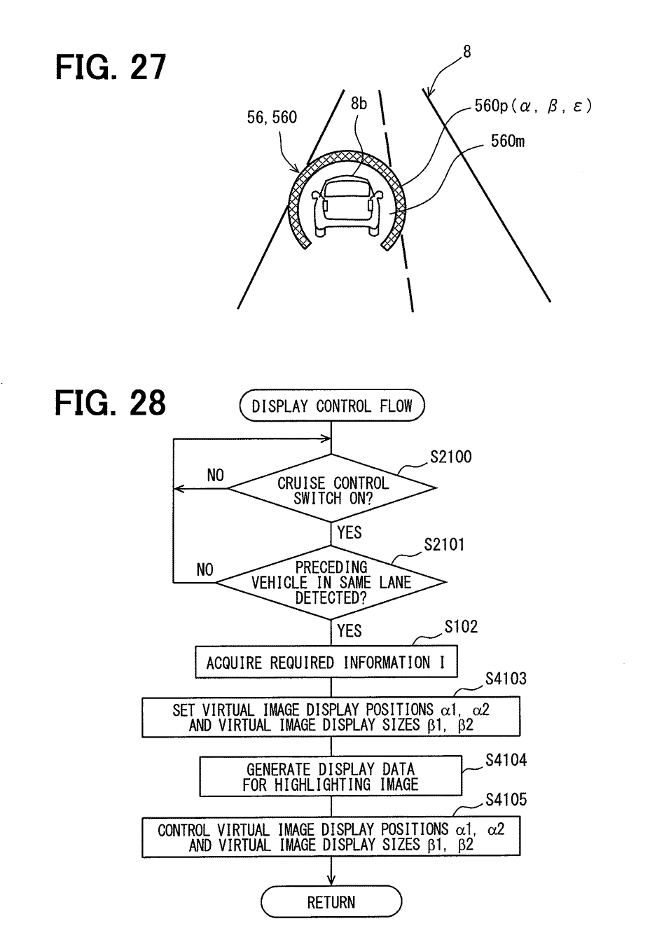

In the following S7103b, as illustrated in FIG. 27, a virtual image display color s of the highlighting image 560 is changed over the entire image 560. At this time, the virtual image display color ε is set to, for example, blue so that the color tone of the highlighting image 560 is dissimilar from the color tone described in the first embodiment. In FIG. 27, a change in the virtual image display color ε is schematically represented by cross-hatching instead of dot-hatching of FIG. 8 in the second embodiment.

In the following S7104, as illustrated in FIG. 26, display data for virtually displaying the highlighting image 560 with the virtual image display color ε set in S7103b in addition to the virtual image display position α and the virtual image display size β set in S7103a is generated. At this time, the display data is generated by applying image processing to data of the highlighting image 560 read from the memory 54m in the same manner as in S104.

In the following S7105, the display data generated in S7104 is provided to the HUD 50 to form the highlighting image 560 by the display device 50i, thereby controlling the virtual image display position α, the virtual image display size β, and the virtual image display color ε of the linear portion 560p. As a result, the highlighting image 560 is visually recognized with the virtual image display color ε changed from FIG. 8 to FIG. 27 in addition to the position α and the size β similar to S105. In the display control flow, a return to S2100 is made after the execution of S7105.

As described above, according to the eleventh embodiment, the virtual image display color ε of the highlighting image 560 is changed along with switching from automatic control driving to manual driving by a user by the integrated control ECU. Accordingly, a user can intuitively understand the switching from automatic control driving to manual driving from the change in the display color of the highlighting image 560. Thus, it is possible to ensure the safety and security for a user using the highlighting image 560. In the above eleventh embodiment, part of the HCU 54 that executes S2100, S7100, S2101, S102, S103, S104, S105, S7101, S7102, S7103a, S7103b, S7104, and S7105 corresponds to the “virtual image display control device” constructed by the processor 54p.

### Other Embodiments

Although the plurality of embodiments of the present disclosure have been described above, the present disclosure is not limited to these embodiments, and can be applied to various embodiments and combinations without departing from the gist of the present disclosure.

In a first modification, the virtual image display control for the highlighting image 4560 according to the fourth embodiment may be applied to the second embodiment. FIG. 28 illustrates a display control flow in a case when the virtual image display control for the highlighting image 4560 according to the fourth embodiment is applied to the second embodiment. That is, in FIGS. 28, S4103, S4104, and S4105 are executed instead of S103, S104, and S105. In the first modification, part of the HCU 54 that executes S2100, S2101, S102, S4103, S4104, and S4105 corresponds to the “virtual image display control device” constructed by the processor 54p.

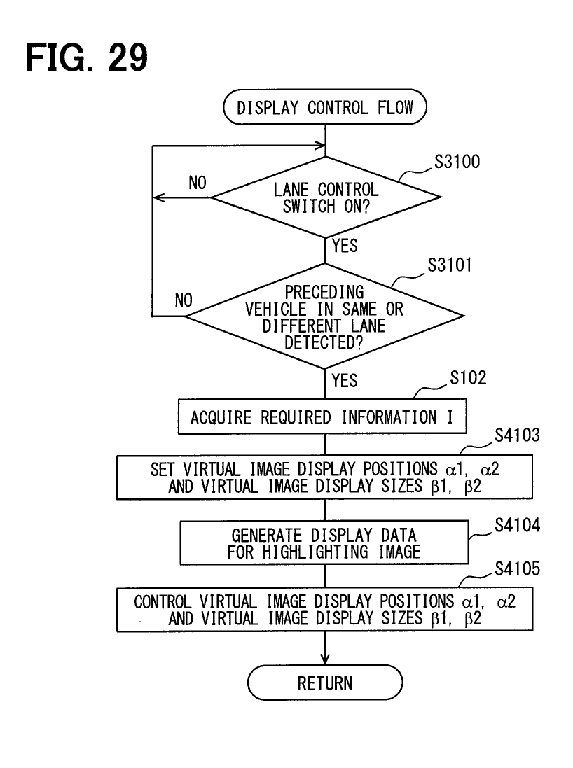

In a second modification, the virtual image display control for the highlighting image 4560 according to the fourth embodiment may be applied to the third embodiment. FIG. 29 illustrates a display control flow in a case when the virtual image display control for the highlighting image 4560 according to the fourth embodiment is applied to the third embodiment. That is, in FIGS. 29, S4103, S4104, and S4105 are executed instead of S103, S104, and S105. In the second modification, part of the HCU 54 that executes S3100, S3101, S102, S4103, S4104, and S4105 corresponds to the “virtual image display control device” constructed by the processor 54p.

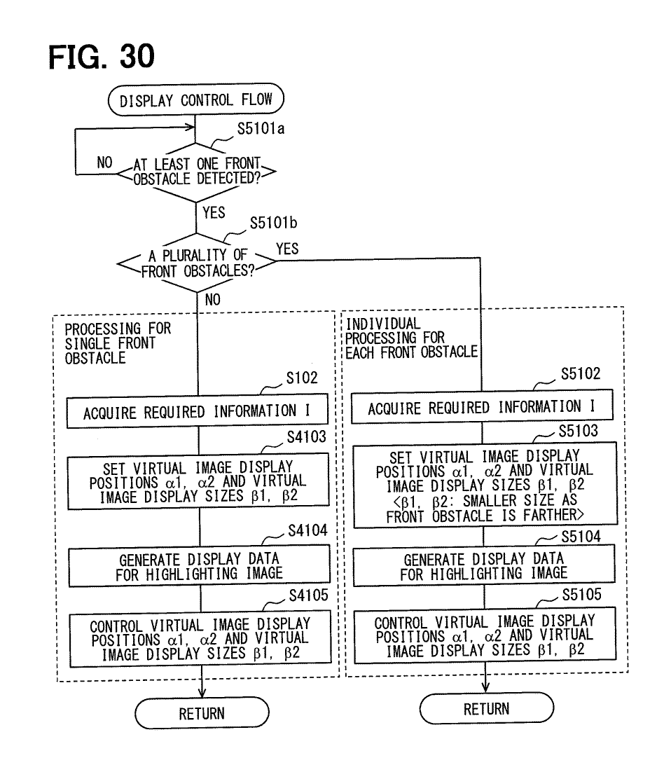

In a third modification, the virtual image display control for the highlighting image 4560 according to the fourth embodiment may be applied to the fifth embodiment. FIG. 30 illustrates a display control flow in a case when the virtual image display control for the highlighting image 4560 according to the fourth embodiment is applied to the fifth embodiment. That is, in FIGS. 30, S4103, S4104, and S4105 are executed instead of S103, S104, and S105. In addition, in FIG. 30, the position α and the size β of the linear portion 560p are changed to the positions α1, α2 and the sizes β1, β2 of the linear portions 4560p1, 4560p2 to execute S5103, S5104, and S5105. In the third modification, part of the HCU 54 that executes S5101a, S5101b, S102, S4103, S4104, S4105, S5102, S5103, S5104, and S5105 corresponds to the “virtual image display control device” constructed by the processor 54p.

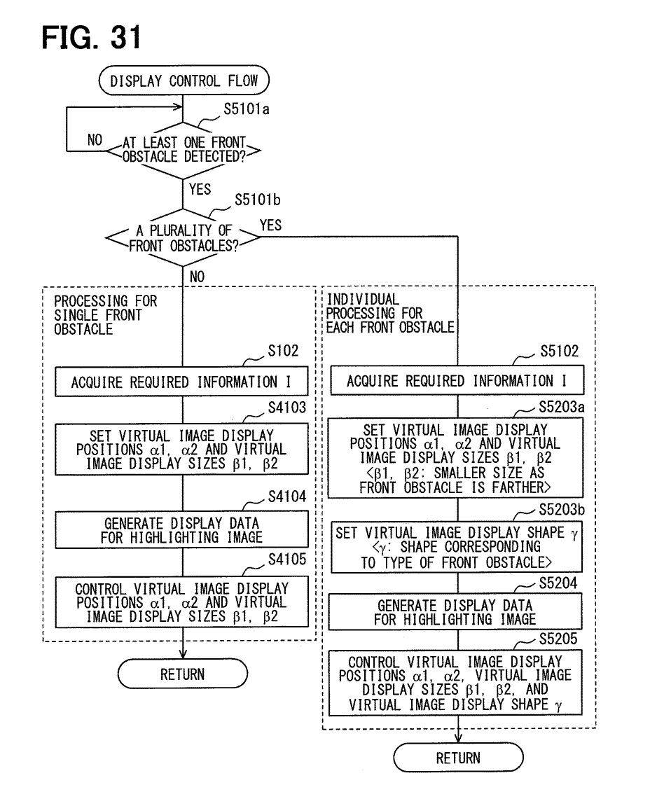

In a fourth modification, the virtual image display control for the highlighting image 4560 according to the fourth embodiment may be applied to the sixth embodiment. FIG. 31 illustrates a display control flow in a case when the virtual image display control for the highlighting image 4560 according to the fourth embodiment is applied to the sixth embodiment. That is, in FIGS. 31, S4103, S4104, and S4105 are executed instead of S103, S104, and S105. In addition, in FIG. 31, the position α and the size β of the linear portion 560p are changed to the positions α1, α2 and the sizes β1, β2 of the linear portions 4560p1, 4560p2 to execute S5203a, S5204, and S5205. Further, in FIG. 31, the virtual image display shape γ of the linear portion 560p is changed to the virtual image display shape γ of the entire highlighting image 4560 including the linear portions 4560p1, 4560p2 to execute S5203b, S5204, and S5205. In the fourth modification, part of the HCU 54 that executes S5101a, S5101b, S102, S4103, S4104, S4105, S5102, S5203a, S5203b, S5204, and S5205 corresponds to the “virtual image display control device” constructed by the processor 54p.

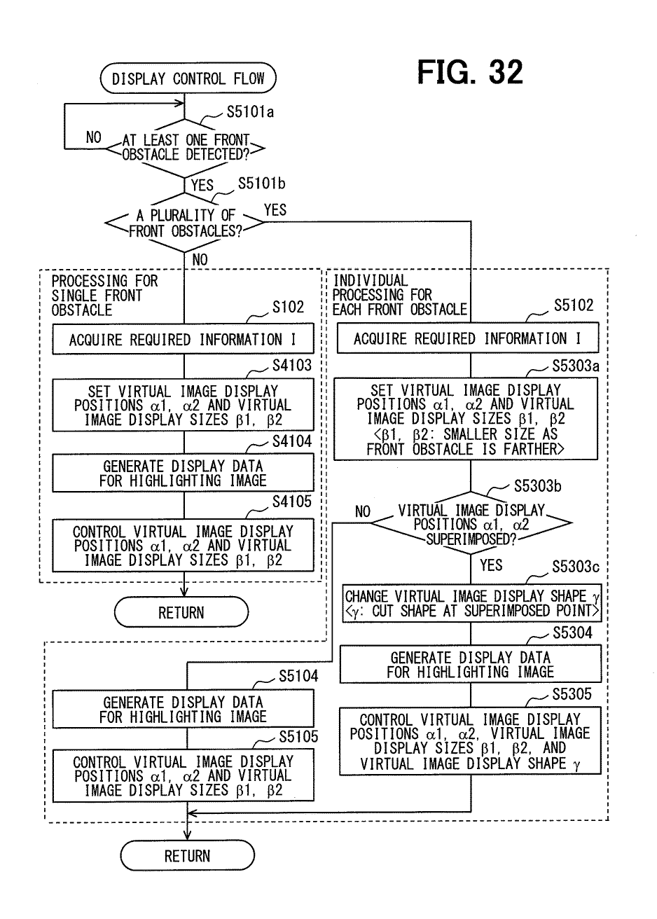

In a fifth modification, the virtual image display control for the highlighting image 4560 according to the fourth embodiment may be applied to the seventh embodiment. FIG. 32 illustrates a display control flow in a case when the virtual image display control for the highlighting image 4560 according to the fourth embodiment is applied to the seventh embodiment. That is, in FIGS. 32, S4103, S4104, and S4105 are executed instead of S103, S104, and S105. In addition, in FIG. 32, the position α and the size β of the linear portion 560p are changed to the positions α1, α2 and the sizes β1, β2 of the linear portions 4560p1, 4560p2 to execute S5303a, S5303b, S5304, S5305, S5104, and S5105. Further, in FIG. 32, the virtual image display shape γ of the linear portion 560p is changed to the virtual image display shape γ of the entire highlighting image 4560 including the linear portions 4560p1, 4560p2 to execute S5303c, S5304, and S5305. In the fifth modification, part of the HCU 54 that executes S5101a, S5101b, S102, S4103, S4104, S4105, S5102, S5303a, S5303b, S5303c, S5304, S5305, S5104, and S5105 corresponds to the “virtual image display control device” constructed by the processor 54p.

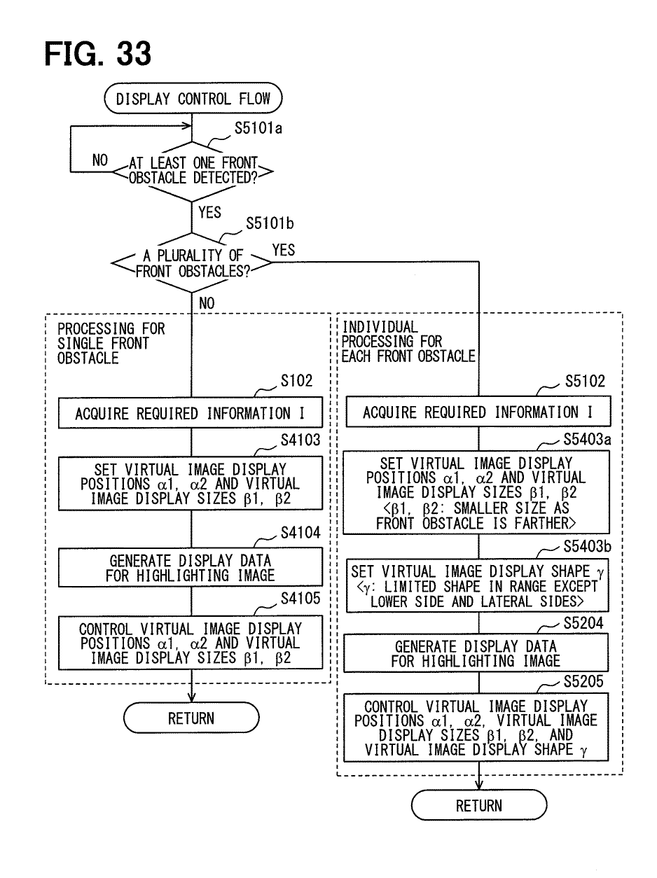

In a sixth modification, the virtual image display control for the highlighting image 4560 according to the fourth embodiment may be applied to the eighth embodiment. FIG. 33 illustrates a display control flow in a case when the virtual image display control for the highlighting image 4560 according to the fourth embodiment is applied to the eighth embodiment. That is, in FIGS. 33, S4103, S4104, and S4105 are executed instead of S103, S104, and S105. In addition, in FIG. 33, the position α and the size β of the linear portion 560p are changed to the positions α1, α2 and the sizes β1, β2 of the linear portions 4560p1, 4560p2 to execute S5403a, S5204, and S5205. Further, in FIG. 33, the virtual image display shape γ of the linear portion 560p is changed to the virtual image display shape γ of the entire highlighting image 4560 including the linear portions 4560p1, 4560p2 to execute S5403b, S5204, and S5205. In the sixth modification, part of the HCU 54 that executes S5101a, S5101b, S102, S4103, S4104, S4105, S5102, S5403a, S5403b, S5204, and S5205 corresponds to the “virtual image display control device” constructed by the processor 54p.

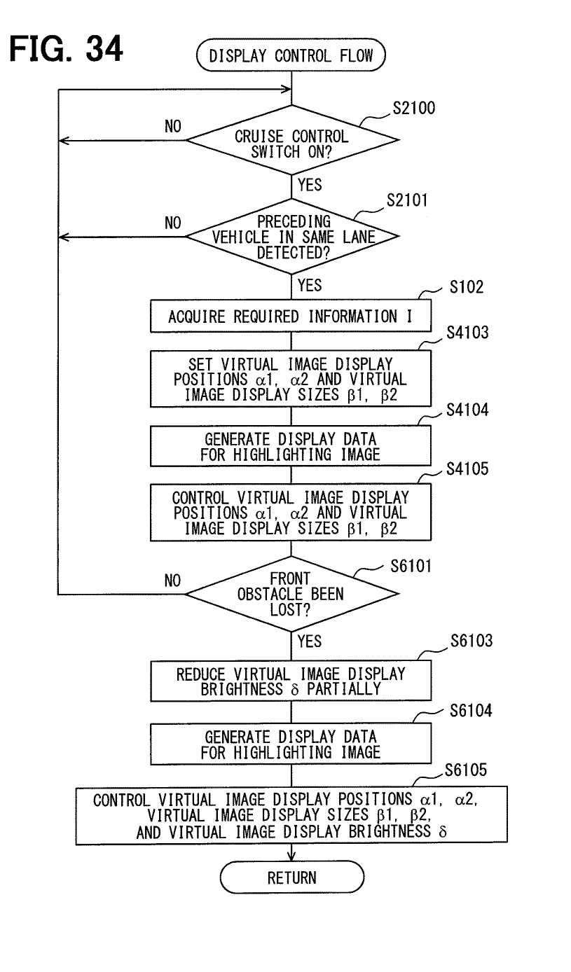

In a seventh modification, the virtual image display control for the highlighting image 4560 according to the fourth embodiment may be applied to the ninth embodiment. FIG. 34 illustrates a display control flow in a case when the virtual image display control for the highlighting image 4560 according to the fourth embodiment is applied to the ninth embodiment. That is, in FIGS. 34, S4103, S4104, and S4105 are executed instead of S103, S104, and S105. In addition, in FIG. 34, the position α and the size β of the linear portion 560p are changed to the positions α1, α2 and the sizes β1, β2 of the linear portions 4560p1, 4560p2 to execute S6104 and S6105. Further, in FIG. 34, the virtual image display brightness δ of the linear portion 560p is changed to the virtual image display brightness δ of each of the linear portions 4560p1, 4560p2 to execute S6103, S6104, and S6105. In the seventh modification, part of the HCU 54 that executes S2100, S2101, S102, S4103, S4104, S4105, S6101, S6103, S6104, and S6105 corresponds to the “virtual image display control device” constructed by the processor 54p.

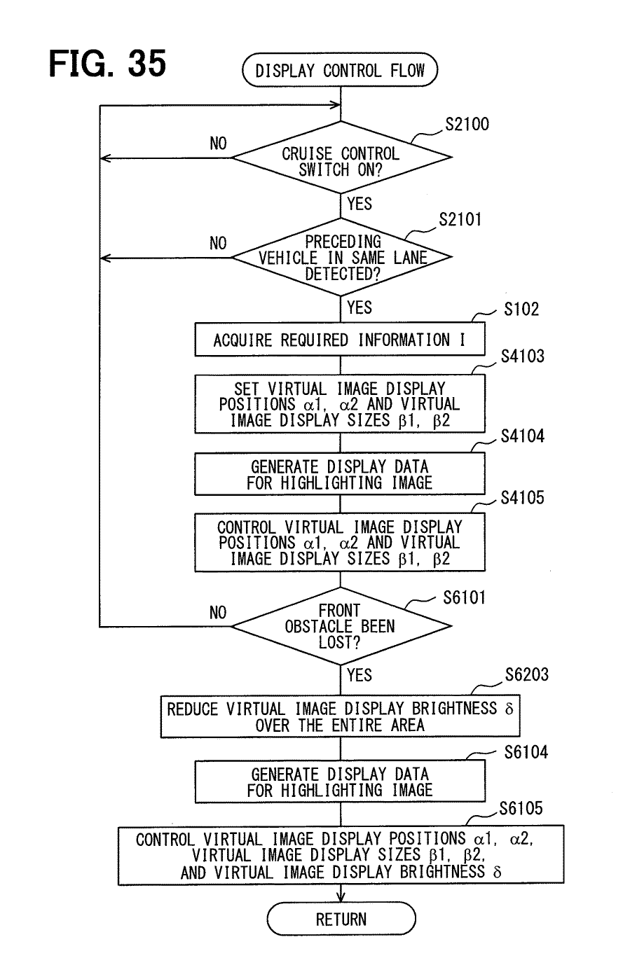

In an eighth modification, the virtual image display control for the highlighting image 4560 according to the fourth embodiment may be applied to the tenth embodiment. FIG. 35 illustrates a display control flow in a case when the virtual image display control for the highlighting image 4560 according to the fourth embodiment is applied to the tenth embodiment. That is, in FIGS. 35, S4103, S4104, and S4105 are executed instead of S103, S104, and S105. In addition, in FIG. 35, the position α and the size β of the linear portion 560p is changed to the positions α1, α2 and the sizes β1, β2 of the linear portions 4560p1, 4560p2 to execute S6104 and S6105. Further, in FIG. 35, the virtual image display brightness δ of the linear portion 560p is changed to the virtual image display brightness δ of each of the linear portions 4560p1, 4560p2 to execute S6203, S6104, and S6105. In the eighth modification, part of the HCU 54 that executes S2100, S2101, S102, S4103, S4104, S4105, S6101, S6203, S6104, and S6105 corresponds to the “virtual image display control device” constructed by the processor 54p.

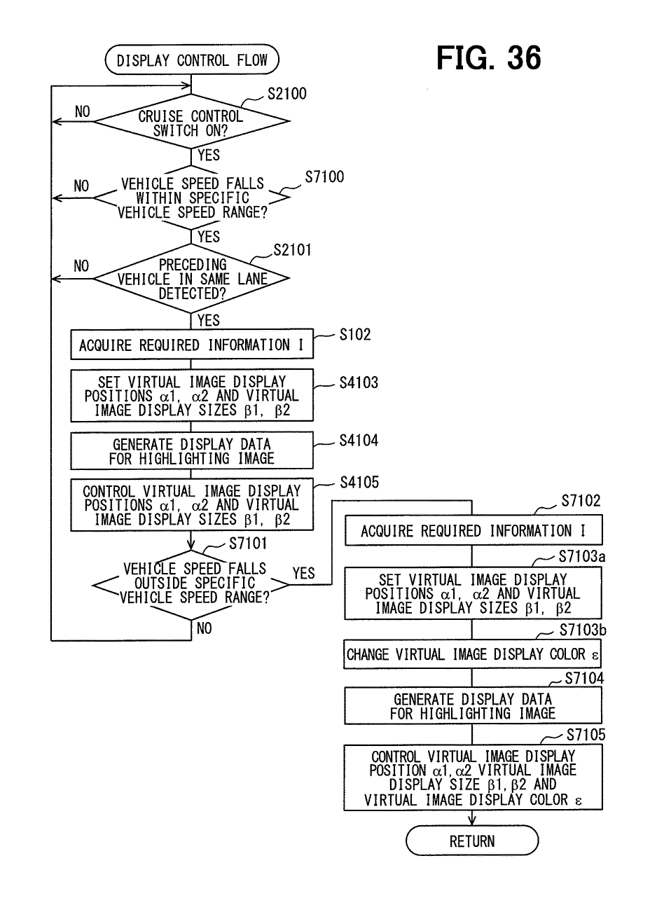

In a ninth modification, the virtual image display control for the highlighting image 4560 according to the fourth embodiment may be applied to the eleventh embodiment. FIG. 36 illustrates a display control flow in a case when the virtual image display control for the highlighting image 4560 according to the fourth embodiment is applied to the eleventh embodiment. That is, in FIGS. 36, S4103, S4104, and S4105 are executed instead of S103, S104, and S105. In addition, in FIG. 36, the position α and the size β of the linear portion 560p are changed to the positions α1, α2 and the sizes β1, β2 of the linear portions 4560p1, 4560p2 to execute S7103a, S7104, and S7105. Further, in FIG. 36, the virtual image display color ε of the linear portion 560p is changed to the virtual image display color ε of each of the linear portions 4560p1, 4560p2 to execute S7103b, S7014, and S7105. In the ninth modification, part of the HCU 54 that executes S2100, S7100, S2101, S102, S4103, S4104, S4105, S7101, S7102, S7103a, S7103b, S7104, and S7105 corresponds to the “virtual image display control device” constructed by the processor 54p.

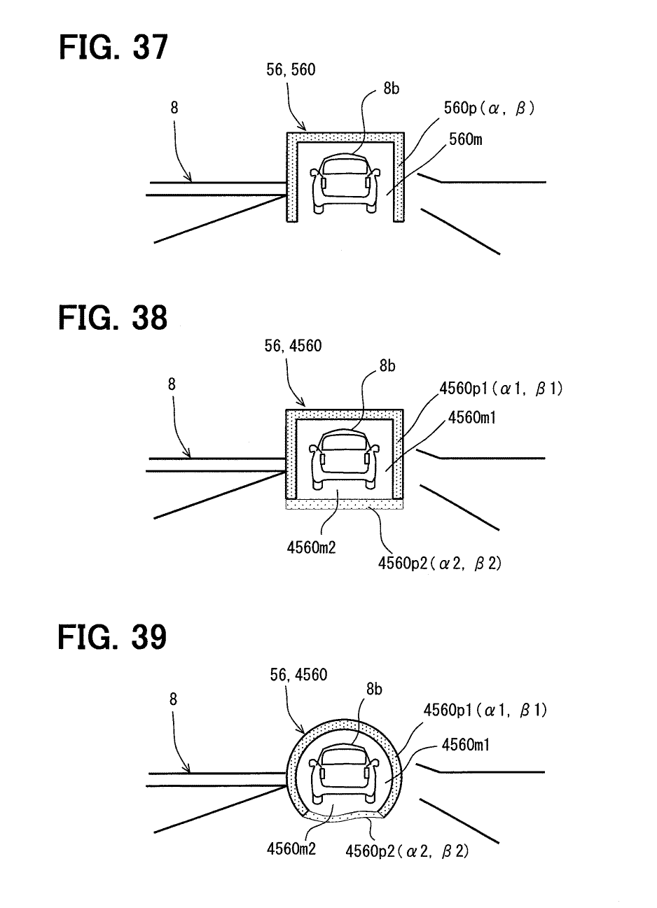

In a tenth modification, the linear portion 560p of the highlighting image 560 virtually displayed by the first to third embodiments and the fifth to eleventh embodiments may be formed in a virtual image display shape other than a curved circular arc shape, for example, a substantially inverted U shape which is not curved as illustrated in FIG. 37. FIG. 37 illustrates the tenth modification of the first embodiment.

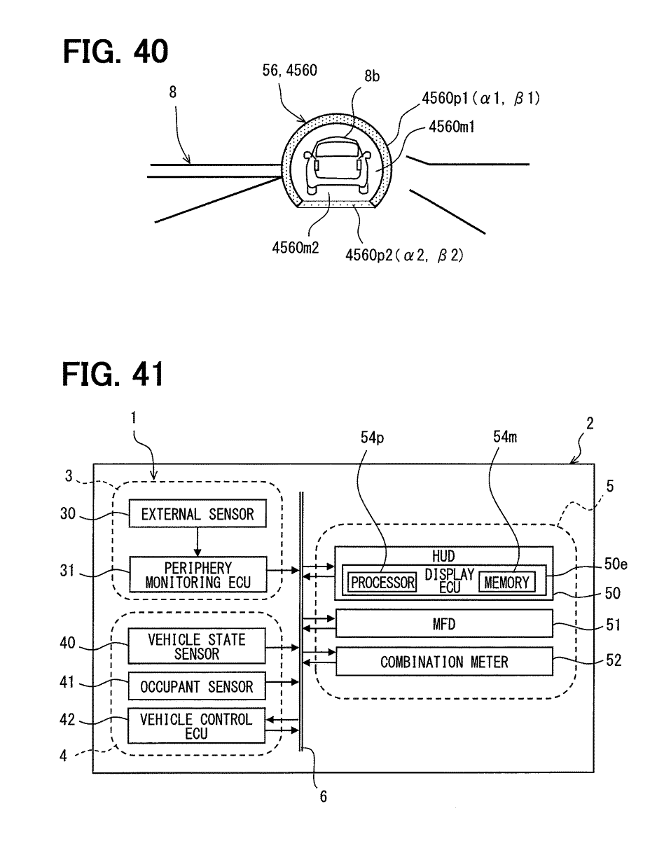

In an eleventh modification, the first linear portion 4560p1 of the highlighting image 4560 virtually displayed by the fourth embodiment and the first to ninth modifications may be formed in a virtual image display shape other than a curved circular arc shape, for example, a substantially inverted U shape which is not curved as illustrated in FIG. 38. In a twelfth modification, the second linear portion 4560p2 of the highlighting image 4560 virtually displayed by the fourth embodiment and the first to ninth modifications may be formed in a virtual image display shape other than a curved circular arc shape, for example, a curved wave shape as illustrated in FIG. 39 or an uncurved linear shape as illustrated in FIGS. 38 and 40. FIGS. 38 to 40 illustrate the eleventh and twelfth modifications of the fourth embodiment.

In a thirteenth modification, the highlighting image 560 or 4560 virtually displayed by the second, third, and ninth to eleventh embodiments and the first, second, and seventh to ninth modifications may be virtually displayed around each of a plurality of front obstacles 8b according to any of the fifth to eighth embodiments and the third to sixth modifications. In a fourteenth modification, the virtual image display sizes β, β1, β2 that become smaller as the front obstacle 8b is farther from the subject vehicle 2 may not be employed in the sixth to eighth embodiments and the fourth to sixth modifications.

In a fifteenth modification, a virtual image display color of a color tone that is varied according to the type of the front obstacle 8b may be employed instead of or in addition to the virtual image display shape γ that is varied according to the type of the front obstacle 8b by the sixth embodiment and the fourth modification. In a sixteen modification, the highlighting image 560 may be caused to blink instead of or in addition to reducing the virtual image display brightness δ of at least part of the highlighting image 560 by the ninth and tenth embodiments and the seventh and eighth modifications.

In a seventeenth modification, the virtual image display color ε may be changed along with switching from manual driving to automatic control driving instead of or in addition to changing the virtual image display color ε along with switching from automatic control driving to manual driving by the eleventh embodiment and the ninth modification. In an eighteenth modification, a virtual image display shape that is changed along with switching from automatic control driving to manual driving may be employed instead of or in addition to the virtual image display color ε that is changed along with the switching from automatic control driving to manual driving by the eleventh embodiment and the ninth modification.

In a nineteenth modification, the seventh embodiment and the fifth modification may be combined with the sixth embodiment and the fourth modification, respectively. In a twentieth modification, the eighth embodiment and the sixth modification may be combined with the sixth embodiment and the fourth modification, respectively. In a twenty-first modification, the ninth embodiment and the seventh modification may be combined with the eleventh embodiment and the ninth modification, respectively. In a twenty-second modification, the tenth embodiment and the eighth modification may be combined with the eleventh embodiment and the ninth modification, respectively.

In a twenty-third modification, the ACC according to the eleventh embodiment and the ninth modification may be performed instead of FSRA by the integrated control ECU of the vehicle control ECU 42 also in the other embodiments and modifications. In a twenty-fourth modification, the integrated control ECU of the vehicle control ECU 42 according to the eleventh embodiment and the ninth modification may be caused to function as the “automatic control unit” that performs LKA to change the virtual image display color ε along with switching from automatic control driving to manual driving by LKA. In this case, the third embodiment and the second modification can be combined. In a twenty-fifth modification, the integrated control ECU of the vehicle control ECU 42 according to the eleventh embodiment and the ninth modification may be caused to function as the “automatic control unit” that performs automatic control driving other than ACC and LKA to change the virtual image display color ε along with switching from the automatic control driving to manual driving. Examples of the applicable automatic control driving other than ACC and LKA include driving that automatically controls merging traveling at a junction on a traveling road, branch-off traveling at a branch point on a traveling road, and traveling from a gate to a junction.

In a twenty-sixth modification, the HCU 54 may not be provided. In the twenty-sixth modification, for example, one or more kinds of ECUs selected from the ECUs 31, 42, and the display ECU provided for controlling the display elements 50, 51, 52 may be caused to function as the “vehicle display control device”. That is, the display control flow of each of the embodiments may be achieved by the processor(s) included in one or more kinds of ECUs to construct the “virtual image display control device”. FIG. 41 illustrates the twenty-sixth modification in a case when the display ECU 50e including the processor 54p and the memory 54m in the HUD 50 functions as the “vehicle display control device”.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A vehicle display control device that controls to display a virtual image in a subject vehicle equipped with a head-up display that displays the virtual image in association with at least one front obstacle in outside scenery by projecting a display image on a projection member for transmitting the outside scenery therethrough, the vehicle display control device comprising:
an image storage device that stores, as the display image, a highlighting image for highlighting the front obstacle by a linear portion having a virtual image display size surrounding the front obstacle with a margin spaced apart from the front obstacle at a virtual image display position corresponding to an entire range less than an entire circumference other than a lower side of a periphery of the front obstacle; and
a virtual image display control device that is provided by at least one processor and controls the virtual image display position and the virtual image display size.

2. The vehicle display control device according to claim 1, wherein:
the linear portion extends in a circular arc shape at the virtual image display position.

3. A vehicle display control device that controls to display a virtual image in a subject vehicle equipped with a head-up display that displays the virtual image in association with at least one front obstacle in outside scenery by projecting a display image on a projection member for transmitting the outside scenery therethrough, the vehicle display control device comprising:
an image storage device that stores, as the display image, a highlighting image for highlighting the front obstacle by a first linear portion, having a first virtual image display size surrounding the front obstacle with a margin spaced apart from the front obstacle at a first virtual image display position corresponding to an entire range less than an entire circumference other than a lower side of a periphery of the front obstacle, and a second linear portion, having a second virtual image display size surrounding the front obstacle with a margin spaced apart from the front obstacle and a lower brightness than the first linear portion at a second virtual image display position between opposing ends of the first linear portion in the periphery of the front obstacle; and
a virtual image display control device that is provided by at least one processor and controls a virtual image display position including the first virtual image display position and the second virtual image display position and a virtual image display size including the first virtual image display size and the second virtual image display size.

4. The vehicle display control device according to claim 3, wherein:
the second linear portion curvedly extends between the opposing ends of the first linear portion at the second virtual image display position.

5. The vehicle display control device according to claim 1, wherein:
the at least one front obstacle includes a plurality of front obstacles; and
the virtual image display control device controls the virtual image display size of each highlighting image, which individually highlights a corresponding one of the front obstacles, to be smaller as the front obstacle to be highlighted is farther from the subject vehicle.

6. The vehicle display control device according to claim 1, wherein:
the at least one front obstacle includes a plurality of front obstacles; and
the virtual image display control device varies a virtual image display shape of each highlighting image, which individually highlights a corresponding one of the front obstacles, according to a type of the front obstacle to be highlighted.

7. The vehicle display control device according to claim 1, wherein:
the at least one front obstacle includes a plurality of front obstacles; and
the virtual image display control device deletes an overlapping portion of the virtual image corresponding to the highlighting image that highlights one of the front obstacles farther from the subject vehicle when virtual image display positions of highlighting images, which individually highlight the front obstacles, overlap with each other.

8. The vehicle display control device according to claim 1, wherein:
the at least one front obstacle includes a plurality of front obstacles; and
the virtual image display control device limits to display the virtual image of each highlighting image, which individually highlights a corresponding one of the front obstacles, to the entire range other than the lower side and a lateral side of the periphery of the front obstacle to be highlighted.

9. The vehicle display control device according to claim 1, wherein:
the subject vehicle equips an inter-vehicle distance control unit that automatically controls an inter-vehicle distance with respect to a preceding vehicle as the front obstacle travelling in a same lane as the subject vehicle; and
the virtual image display control device controls a position of the highlighting image to a position for highlighting the preceding vehicle.

10. The vehicle display control device according to claim 1, wherein:
the subject vehicle equips a lane control unit that automatically controls a width-direction position of the subject vehicle in a traveling lane; and
the virtual image display control device controls a position of the highlighting image to a position for highlighting a preceding vehicle as the front obstacle that travels in a same lane as or a different lane from the traveling lane.

11. The vehicle display control device according to claim 1, wherein:
the virtual image display control device reduces a virtual image display brightness of at least a part of the highlighting image that highlights a lost front obstacle when the front obstacle once detected is lost.

12. The vehicle display control device according to claim 1, wherein:
the subject vehicle is switchable between a manual driving operation by a user and an automatic control driving operation by an automatic control unit; and
the virtual image display control device changes a virtual image display color of the highlighting image when switching from the automatic control driving operation to the manual driving operation.

13. A vehicle display unit comprising:
the vehicle display control device according to claim 1; and the head-up display.
